(19) United States
(12) Patent Application Publication
(10) Pub. No.: US 2026/0187445 A1
(43) Pub. Date: Jul. 2, 2026

(54) METHODS AND APPARATUS FOR SELF-GOVERNING ARTIFICIAL INTELLIGENCE (AI) MODELS

(71) Applicant: OPENCHIP &SOFTWARE TECHNOLOGIES S.L., Barcelona (ES)

(72) Inventors: Francesc Guim Bernat, Barcelona (ES); Violante Moschiano, Avezzano (IT); Gaspar Mora Porta, Castellon de la Plana (ES); Satoru Tagaya, Barcelona (ES); Tommaso Vali, Sezze (IT); Erich Ludwig Focht, Stuttgart (DE); Edgar Gonzalez Pellicer, Girona (ES)

(21) Appl. No.: 19/043,167

(22) Filed: Jan. 31, 2025

Related U.S. Application Data
(63) Continuation of application No. PCT/EP2024/088652, filed on Dec. 30, 2024.

(30) Foreign Application Priority Data
Dec. 30, 2024 (WO) PCT/EP2024/088652

(51) Int. Cl. G06N 3/08; G06F 21/72; H04L 9/32

(52) U.S. Cl. CPC G06N 3/08; G06F 21/72; H04L 9/3268

(57) ABSTRACT

An example apparatus includes interface circuitry, machine-readable instructions, and at least one processor circuit to be programmed by the machine-readable instructions to identify a data provider with access to training data for performing a second training of a machine learning model, a first training of the machine learning model performed by a software stack of at least one of a chiplet associated with a system-on-a-chip (SoC), a chip portion of a chipset, or a die part, perform attestation of the data provider using a first encryption key, the attestation based on a validation of the data provider using a server, receive the training data from the data provider using a second encryption key, the first encryption key and the second encryption key generated by the at least one of the chiplet, the chip portion of the chipset, or the die part.

### STATEMENT REGARDING GOVERNMENT SUPPORT

The work leading to this invention has received funding from the European Union-Next Generation, Important Projects of Common European Interest (IPCEI). In particular, this invention was made with government support under Grant UNICO-IPCEI-2023-001 funded by the European Union-Next Generation IPCEI.

### FIELD OF THE DISCLOSURE

This disclosure relates generally to compute devices and, more particularly, to self-governing artificial intelligence models implemented by compute devices.

### BACKGROUND

Artificial intelligence (AI)-based models use training to enhance model performance based on a variety of training data formats (e.g., text data, speech data, image data, video data, sensor data, etc.). The training data can be fed into AI models as input for supervised learning (e.g., using labelled data), unsupervised learning (e.g., using unlabeled data), and/or reinforcement learning.

### BRIEF DESCRIPTION OF THE DRAWINGS

FIG. 1 illustrates an example known method of AI model training using a data center/cloud service provider (CSP) with data collection (e.g., from a user and/or sensors) occurring on the edge.

FIG. 2 is a block diagram of an example implementation of training performer circuitry constructed in accordance with teachings of this disclosure for self-governing artificial intelligence (AI) models.

FIG. 3 is a flowchart representative of example machine-readable instructions and/or example operations that may be executed, instantiated, and/or performed by example programmable circuitry to implement the example training performer circuitry of FIG. 2.

FIG. 4 is a flowchart representative of example machine-readable instructions and/or example operations that may be executed, instantiated, and/or performed by example programmable circuitry to implement the example training performer circuitry of FIG. 2 to perform a handshake with and/or attestation of the data provider to securely receive and store training data set(s).

FIG. 5 is a flowchart representative of example machine-readable instructions and/or example operations that may be executed, instantiated, and/or performed by example programmable circuitry to implement the example training performer circuitry of FIG. 2 to perform training of an AI model using keys created during the handshake with the data provider.

FIG. 6 is a flowchart representative of example machine-readable instructions and/or example operations that may be executed, instantiated, and/or performed by example programmable circuitry to implement a computing system of FIG. 2 to cause the computing system to train, re-train, and/or tune the AI model using the stored training data.

FIG. 7 illustrates a first example implementation of a trusted training chiplet or device for AI model training in accordance with teachings of this disclosure for self-governing artificial intelligence (AI) models.

FIG. 8 illustrates a second example implementation of a trusted training chiplet or device for AI model training in accordance with teachings of this disclosure for self-governing artificial intelligence (AI) models, including the use of the training performer circuitry of FIG. 2.

FIG. 9 illustrates an example hardware arrangement of an example data center.

FIG. 10A illustrates an example arrangement of an example chip assembly of FIG. 9

FIG. 10B illustrates an example arrangement of an example chip assembly of FIG. 9, adapted for high-performance computing applications.

FIG. 11 is a block diagram of an example processing platform including programmable circuitry structured to execute, instantiate, and/or perform the example machine readable instructions and/or perform the example operations of FIGS. 3-5 to implement the training performer circuitry of FIG. 2.

FIG. 12 is a block diagram of an example processing platform including programmable circuitry structured to execute, instantiate, and/or perform the example machine readable instructions and/or perform the example operations of FIG. 6 to implement the computing system of FIG. 2.

FIG. 13 is a block diagram of an example implementation of the programmable circuitry of FIGS. 11-12.

FIG. 14 is a block diagram of another example implementation of the programmable circuitry of FIGS. 11-12.

FIG. 15 is a block diagram of an example software/firmware/instructions distribution platform (e.g., one or more servers) to distribute software, instructions, and/or firmware (e.g., corresponding to the example machine readable instructions of FIGS. 3-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or similarly functioning parts. The figures are not necessarily to scale.

### DETAILED DESCRIPTION

Edge computing allows for distributed computing in which computation is performed largely or completed on distributed edge device nodes (e.g., edge computing nodes), as opposed to primarily taking place in a centralized cloud environment. The use of edge computing reduces the workload from cloud computing and/or allows for computing to occur closer to the end-user and/or end-device for improved performance. Edge computing includes telco edge computing (e.g., edge computing infrastructure provided by a telecommunications company), enterprise edge computing (e.g., edge computing infrastructure provided by an individual company's network), edge deployments supported by cloud computing, and Internet of Things (IoT) as well as hybrid arrangements of these implementations. In some examples, edge computing can be deployed in emerging markets with limited connectivity using cost-efficient and power-efficient edge appliances (e.g., by implementing fifth generation (5G) mobile network backhaul connectivity provided by micro-satellites).

Additionally, edge computing can be used to support computationally intensive artificial intelligence (AI)-based applications on edge devices. In some examples, machine learning algorithms can be deployed to an edge device where training data is generated. For example, numerous sensors and smart devices generate data at the edge of the network, while processing the data at the edge increases efficiency. AI-based applications (e.g., located at the edge and/or in the cloud) can be used to analyze large amounts of data and extract insights from the data for high-quality decision-making. For example, machine learning models can assess data collected at the edge device (e.g., using sensors) to identify patterns and/or deviations in the data (e.g., humidity, temperature, traffic flow, air quality, etc.). Powering AI-based applications can be more efficient using edge computing through reductions in cost and latency, as well as increased reliability and data-based privacy. For example, deployment of AI-based applications at the edge reduces the latency and associated costs of cloud-based processing. Similarly, data privacy is enhanced when raw data (e.g., data used for training the machine learning model) is stored and/or accessed locally on the edge device and/or a user device. For example, machine learning model training uses raw data (e.g., captured by sensors), which can include user-specific data. Examples of user-specific data usage can include deployment of a personal assistant model that is adapted to a given user's environment based on user-specific data and ambient conditions (e.g., noise) of a given location. Such data can include voices of individuals located in the user's environment (e.g., used for training the model to perform certain tasks, etc.). In some examples, raw data can be protected using methods such as differential privacy (e.g., adding random noise to the data before analysis), homomorphic encryption (e.g., performing computations on encrypted data without decryption), and/or federated learning (e.g., decentralized model training by keeping data locally on user devices).

Known methods of training and/or tunning AI-based models at the edge include incorporating automation in the cloud to allow for model re-tuning and/or re-evaluation (e.g., based on new data sets that are discovered at the edge). Such methods assume the presence of automatic data labelling and/or pre-processing occurring at a data center, as well as sharing of data sets between the user and a training entity. In some examples, training of new models can occur at the local edge or on the cloud (e.g., due to a lack of compute power at the edge, etc.), relying on a software entity to process the collected data to train and/or re-train the model. However, such methods can compromise the data security and/or privacy standards associated with the raw data. In some examples, privacy concerns can be addressed by data minimization (e.g., collecting only necessary data points required for a given machine learning task), data anonymization (e.g., obfuscating identifiable information), and/or introduction of access control requirements. However, such actions can reduce data accessibility for model training purposes, affecting outcomes associated with the trained machine learning model after deployment.

Methods and apparatus disclosed herein introduce a local and data center-based re-training architecture (e.g., a machine learning model training architecture), allowing the training-based data and the machine learning model to be managed by a trusted entity. As used herein, trust refers to a degree of confidence (sometimes referred to as a credibility factor and/or a trustworthiness) that an entity (e.g., a node, a chiplet, a server, etc.) will act in an expected manner. Such confidence may be based on any number of different factors including established protocols, reputations, cryptographic guarantees, previous interactions, etc. The actions that may be expected by the entity may relate to how the entity handles information that is provided to the entity (e.g., the information is not exfiltrated to third parties, the information is stored in a secure manner, etc.), adherence to established protocols, etc. A device may be “trusted” when the degree of confidence meets a trustworthiness and/or a credibility factor threshold (e.g., based on a given data variable, integer, etc.). In some examples, different factors of operation of a device may be weighted differently when determining the degree of confidence for the device. In some examples, the determination of trustworthiness might be performed by a third party (e.g., a trust authority). In some examples, trust and/or a trust attribute can be assigned to data, data set(s), data series, collections of data, and/or any other type of data-based information. In some examples, trust and/or a trust attribute can be assigned to one or more location(s) where the data and/or any type of data-based information is stored.

For example, trust attributes can be output as values, such as one or more numeric values, one or more text values, etc., that can be evaluated through one or more operations (e.g., comparisons, concatenations, summations, differences, etc.). For example, two or more different trust attributes can be combined to develop an overall trust value or score for an entity such as a compute device, a processor circuitry, a tile and/or a chiplet. In some examples, the values of individual trust attributes and/or different combinations of trust attributes can be used to develop several composite trust value(s) or score(s) (e.g., at different hierarchical levels) for the compute device, the processor circuitry, the tile, and/or the chiplet. In some examples, trust attributes may also refer to competence attribute(s) and/or compliance attribute(s), integrity attribute(s), assurance attribute(s), validation/validity attribute(s), privacy attribute(s), reliability attribute(s), credibility attribute(s), safety attribute(s), explainability attribute(s), trustworthiness attribute(s), etc.

In examples disclosed herein, a chiplet and/or a subsystem can be used to perform the training of a particular model without providing access of the training data to any software stack running in a server location, thereby improving raw data security and ensuring a high level of data privacy. As described in more detail in examples disclosed herein, chiplets are modular semiconductor components designed for specific performance (e.g., data storage, signal processing, etc.), offering a cost-effective, high-performance alternative to traditional monolithic chips. For example, chiplets can be integrated together to form a complete system-on-a-chip (SoC), with different types of chiplets available for selection based on computational needs (e.g., compute chiplets, memory chiplets, input/output (I/O) chiplets, etc.). In particular, chiplets are well-suited for applications associated with edge computing and the Internet of Things (IoT).

In examples disclosed herein, a designated data provider can perform multiple actions associated with trusted training device(s), including discovering the trusted training device(s) in a system, attesting and/or validating whether the trusted training device(s) are trusted (e.g., via a trusted authority), sending secure data to the trusted training device(s) using a private key (e.g., provided via a handshake), and/or providing validation to the trusted training device(s) that the data provider is trustworthy (e.g., allowing the trusted training device(s) to reject the data provider if validation is not obtained). In examples disclosed herein, raw data (e.g., machine learning model training data) is securely stored in a trusted training component, becoming accessible to software with access to a given hardware application programming interface (API). In examples disclosed herein, the trusted training component includes (1) an API associated with proof-of-identity, allowing a given data provider to validate the entity of the trusted training component, (2) an API to establish communication between the data provider and the trusted training component (e.g., for sending or streaming data sets used as part of training the machine learning model, etc.), and/or (3) an API to allow software stack running in a separate compute element (e.g., to perform training, re-training, and/or tuning of the machine learning model using a given data set). As such, methods and apparatus disclosed herein secure training data for AI-based applications using a trusted training component. In examples disclosed herein, the trusted training component is part of a chiplet designed to support data flow management, attestation management, and/or training management associated with the training data.

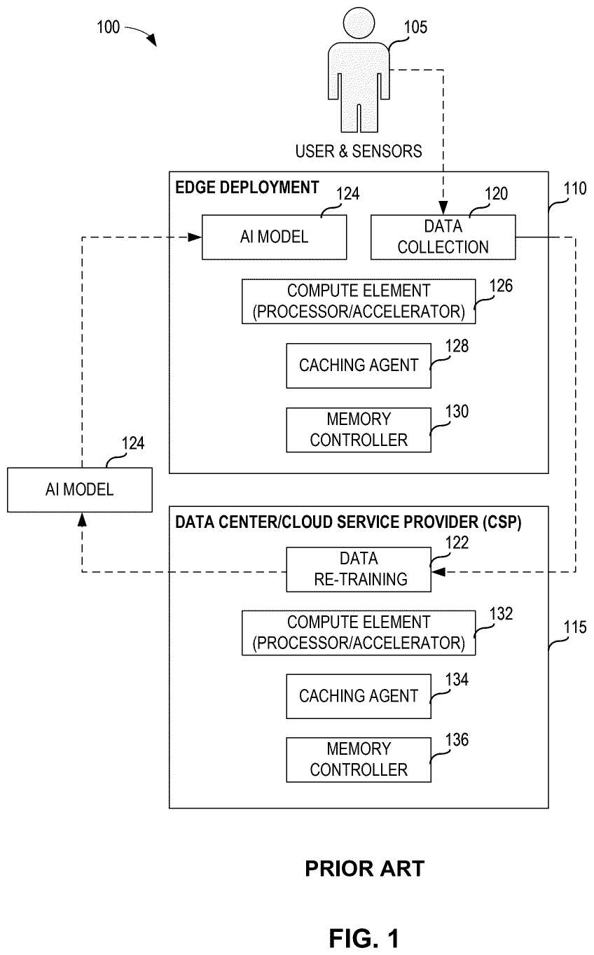

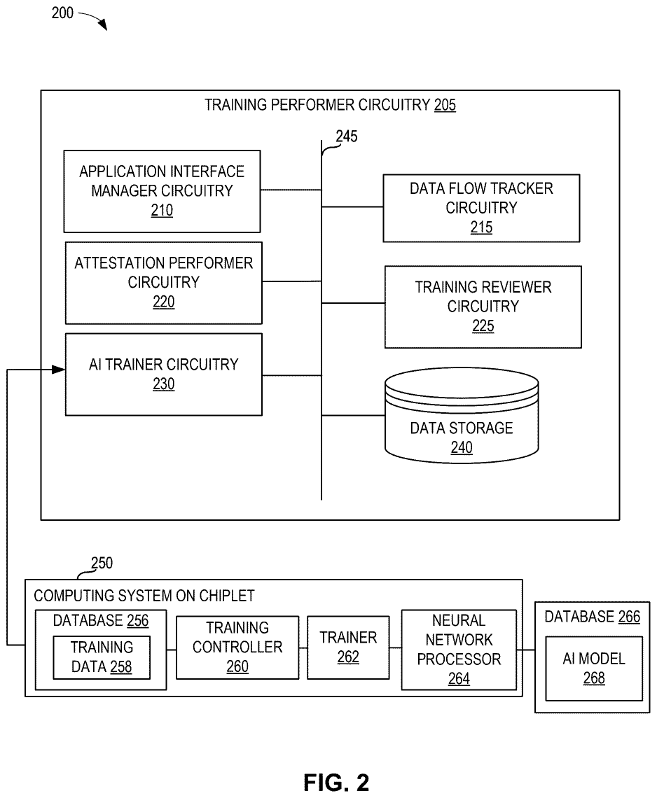

FIG. 1 illustrates an example known method of AI model training 100 using a data center/cloud service provider (CSP) with data collection occurring on the edge. In the example of FIG. 1, a data contributor 105 (e.g., user and/or sensors) provides data to an edge-deployed compute system 110 which is in communication with a data center and/or a cloud service provider (CSP) 115. For example, data collection 120 occurring on the edge-deployed compute system 110 is provided to the data center/CSP 115 for data-based re-training 122 to generate an updated AI model 124. Subsequently, the updated AI model 124 (e.g., re-trained using the collected data) is returned to the edge-deployed compute system 110. In the example of FIG. 1, the edge-deployed compute system 110 includes a first compute element 126 (e.g., a processor(s)/accelerator), a first caching agent 128, and a first memory controller 130. In the example of FIG. 1, the data center/CSP 115 includes a second compute element 132 (e.g., a processor/accelerator), a second caching agent 134, and a second memory controller 136. FIG. 1 illustrates re-training and/or tuning of a machine learning model deployed on the edge using some level of authorization in the cloud (e.g., via the data center/CSP 115). For example, the data center/CSP 115 can be used to re-train and/or tune the AI model 124 using the collected data identified on the edge (e.g., via the data contributor 105). While training of the AI model 124 could take place locally on the edge, such training is typically performed using the data center/CSP 115 due to limited computing power locally on the edge. In the example of FIG. 1, the edge-deployed compute system 110 and the data center/CSP 115 are separate entities that handle AI model training with the assumption that the raw data originating from the data contributor 105 is continuously available. However, if the data contributor 105 imposes a restriction on raw data availability (e.g., making the data only locally available), there is a challenge associated with making the raw data available for machine learning model training while storing and/or collecting the data locally (e.g., without providing the collected data to the data center/CSP 115). In examples disclosed herein, a machine learning model training architecture (e.g., a chiplet-based machine learning model re-training architecture) is introduced, allowing for edge-located, local AI model re-training such that the raw data provider and/or the AI model re-training circuitry system are managed by a trusted authority (e.g., a trusted server), as described in more detail in connection with FIGS. 2 and 7-8.

FIG. 2 is a block diagram 200 illustrating an example implementation of training performer circuitry 205 constructed in accordance with teachings of this disclosure for self-governing AI models. The training performer circuitry 205 of FIG. 2 may be instantiated (e.g., creating an instance of, bring into being for any length of time, materialize, implement, etc.) by programmable circuitry such as a Central Processing Unit (CPU) executing first instructions. Additionally or alternatively, the training performer circuitry 205 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the example of FIG. 2, the training performer circuitry 205 includes example application interface manager circuitry 210, example data flow tracker circuitry 215, example attestation performer circuitry 220, example training reviewer circuitry 225, example AI trainer circuitry 230, and example data storage 240. In the example of FIG. 2, the application interface manager circuitry 210, the data flow tracker circuitry 215, the attestation performer circuitry 220, the training reviewer circuitry 225, the AI trainer circuitry 230, and the data storage 240 are in communication with an example bus 245.

The application interface manager circuitry 210 receives data from compute tile(s) or compute unit(s) on a chiplet and/or a data provider. As used herein, a chiplet refers to any integrated circuit (IC) that has a modular structure designed to have one or more specified functionalities and to be combined with other chiplets on an interposer or other substrate in a package. Examples of chiplets are compute chiplets that include processor circuitry (e.g., one or more processor circuits, such as one or more cores, etc.) and supporting circuitry (e.g., local memory, etc.) to provide processor functionality (e.g., to execute a host OS, applications, etc.), memory chiplets that include memory accessible to one or more other chiplets, communication chiplets that include communication interfaces (e.g., input/output hubs, networks, etc.) to enable other chiplets to communicate with each other and/or to other devices external to the package, etc. As used herein, a tile refers to any IC that has a modular structure designed to have specified functionality and to be combined with other tiles in a chiplet. Examples of tiles are compute tiles that include one or more processor circuits (e.g., cores) and supporting circuitry (e.g., local memory) to provide processor functionality (e.g., to execute a host OS, applications, etc.) in a chiplet, memory tiles that include memory accessible to one or more other tiles in the chiplet, memory controller tiles to control access to the memory tiles in the chiplets, etc.

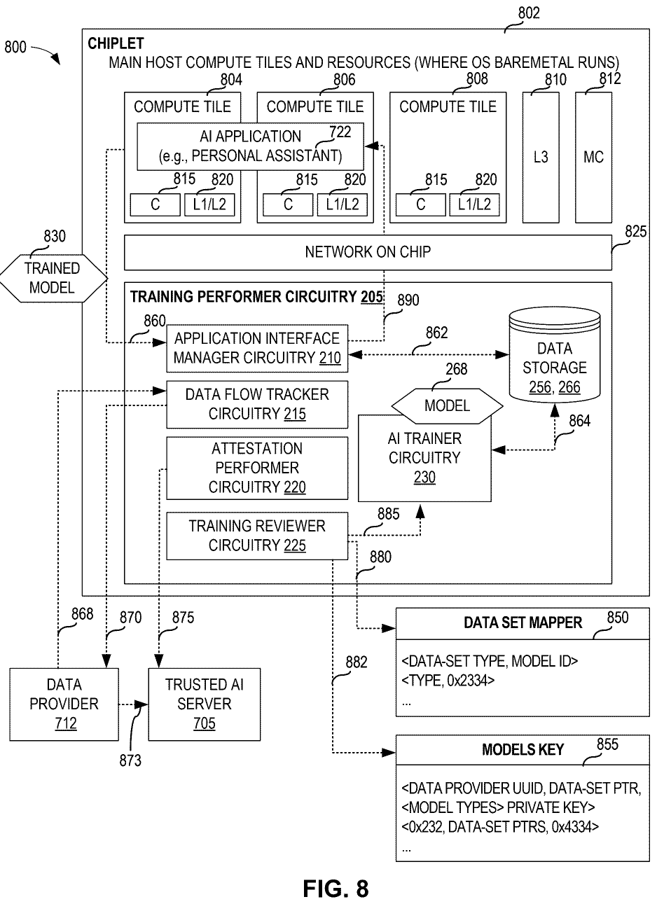

In some examples, the application interface manager circuitry 210 transmits data received from the compute tile(s) and/or the data provider to a data storage (e.g., data storage 240, data storage 256, etc.). In examples disclosed herein, the application interface manager circuitry 210 receives data from an AI application (e.g., a personal assistant), as described in more detail in connection with FIG. 8. In some examples, the application interface manager circuitry 210 includes one or more hardware-based application programming interface(s) (HW APIs). In examples disclosed herein, the training performer circuitry 205 (e.g., a trusted training component (TCC) of a chiplet) trains models (e.g., AI model(s)) with data sets that are not accessible to a software stack running in a bare-metal host. For example, a bare-metal host or server represents a form of cloud service in which the user rents a physical machine from a provider that is not shared with any other tenants (e.g., a computer server dedicated to a single customer or tenant). As used herein, a bare metal host or operating system (OS) refers to an OS that has access to the physical resources (e.g., hardware and/or firmware) of the compute device. In some examples, the bare metal OS corresponds to a host OS that executes on the compute device to provide applications with access to the physical resources of the compute device. In some examples, the bare metal OS is a physical OS that executes below a virtual OS on the compute device and that provides the virtual OS with access to the physical resources of the compute device.

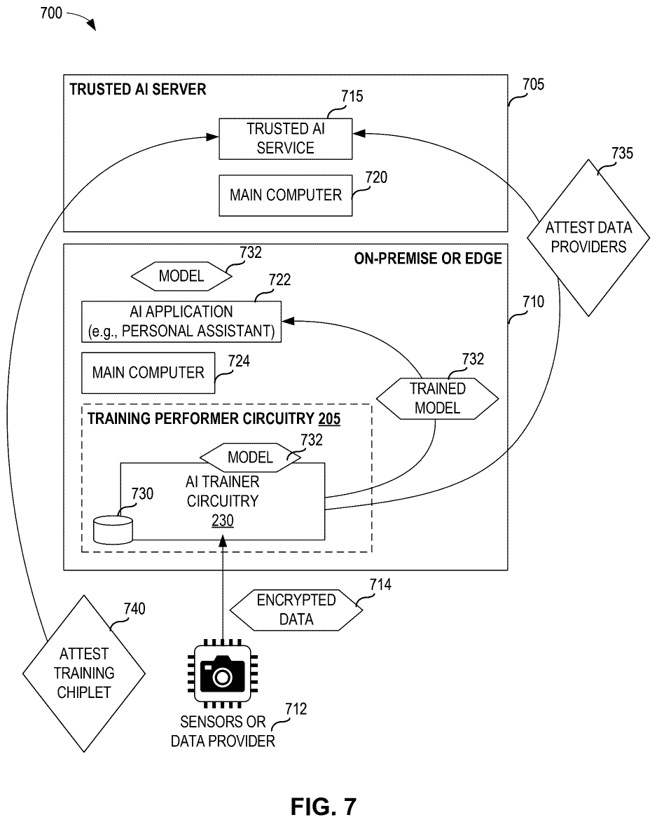

In examples disclosed herein, the training performer circuitry 205 is in communication (e.g., via the application interface manager circuitry 210) with the software stack (e.g., a collection of software tools and frameworks) associated with the chiplet on which the training performer circuitry 205 is housed. In some examples, the training performer circuitry 205 is a chiplet associated with a system-on-a-chip (SoC), a chip portion of a chipset, and/or a die part of a system. Notwithstanding the location and/or integration of the training performer circuitry 205, in examples disclosed herein the training performer circuitry 205 is secured and only accessible using the application interface manager circuitry 210. For example, the application interface manager circuitry 210 receives data from the data provider (e.g., a sensor), such that the received data can be used by local software stacks to locally re-train and/or tune specific models (e.g., AI models), as shown in more detail in connection with FIGS. 7-8. For example, the application interface manager circuitry 210 identifies a data provider with access to training data for performing a second training and/or a subsequent training (e.g., a local training) of a machine learning model, whereas a first training of the machine learning model (e.g., a previous training) is originally performed by the software stack of the chiplet (e.g., using an AI application, etc.). In some examples, the data provider (e.g., a sensor) can be one of a camera, a temperature sensor, a pressure sensor, a humidity sensor, a proximity sensor, a light sensor, an ultrasound sensor, an optical sensor, a motion sensor, and/or any other type of sensor.

In examples disclosed herein, the application interface manager circuitry 210 securely stores data sets (e.g., received from the data provider) associated with different models to be trained, while the AI trainer circuitry 230 accesses the data sets to update the models (e.g., AI model(s)). For example, the application interface manager circuitry 210 can include an application programming interface (API) to receive proof-of-identity (e.g., out-of-band), allowing a given data provider to validate an entity associated with the application interface manager circuitry 210. In some examples, the application interface manager circuitry 210 can include an API to establish a communication channel (e.g., out-of-band) between the training performer circuitry 205 and the data provider (e.g., to send and/or stream data sets to the training performer circuitry 205). In some examples, the communication channel can be associated with a set of variables (e.g., variables associated with one or more data sets needed to train models locally). In some examples, the application interface manager circuitry 210 includes an API to allow a software stack running in a separate compute element (e.g., an AI application) to train, re-train and/or perform tuning of a particular model with a given data set. In examples disclosed herein, the application interface manager circuitry 210 can receive (e.g., via an API) a pointer to an existing and/or a current model implemented by the software stack (e.g., a trained AI model). For example, if the existing AI model is large, the pointer can be a memory pointer to the current model weights and/or thresholds. In some examples, the application interface manager circuitry 210 receives a universally unique identifier (UUID) of a model type (e.g., represented by the AI model). For example, the UUID can indicate the corresponding data sets that can be and/or need to be used (e.g., for further training, retraining, and/or tuning of the existing AI model). In examples disclosed herein, the AI model can be defined by a set of input variables (e.g., Vᵢ¹, . . . , Vᵢₙ) and/or a set of response variable (e.g., Vₒ¹, . . . , Vₒₙ), where certain type(s) of variables are identified by the UUID. In examples disclosed herein, a data set is defined based on a set of variables (e.g., D₁, . . . , Dₙ), such that each entry of a data set is associated with a temporal reference (e.g., nanoseconds, hours, etc.).

In some examples, the application interface manager circuitry 210 receives rule(s) that define a portion of the data set to apply during model re-training and/or tuning. In examples disclosed herein, given that the chiplet-based software stack lacks access to raw data (e.g., received from the data provider), the software stack (e.g., AI application in communication with the application interface manager circuitry 210) can filter the received data to determine which data sets are to be used for model training and/or re-training. In some examples, the application interface manager circuitry 210 receives communication from the software stack specifying the use of data sets generated (e.g., by the data provider) at a given time point and/or at a given frequency (e.g., during the last week). For example, the data provider(s) providing data to the training performer circuitry 205 can be external or internal components, including one or more sensor(s) (e.g., thermal sensors, imaging sensors, temperature sensors, motion sensors, etc.) and/or external or internal software stacks generating data sets.

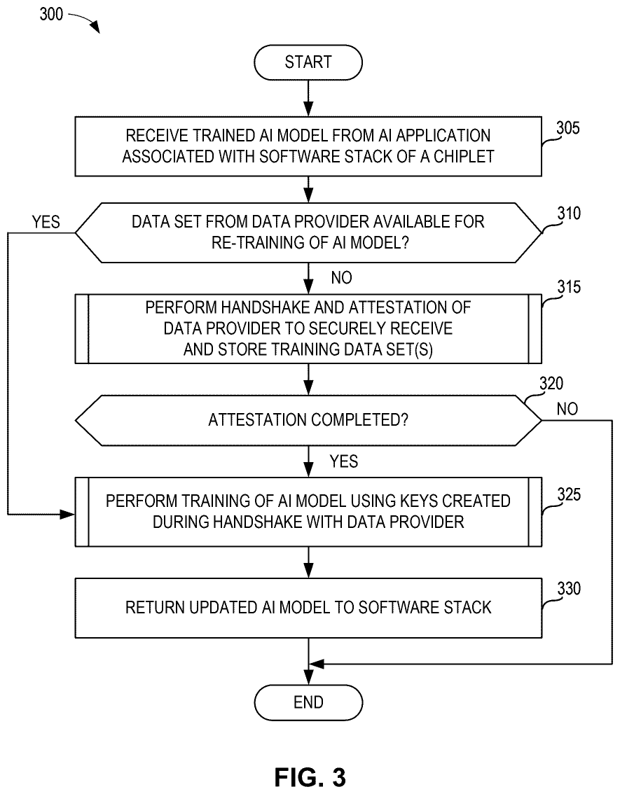

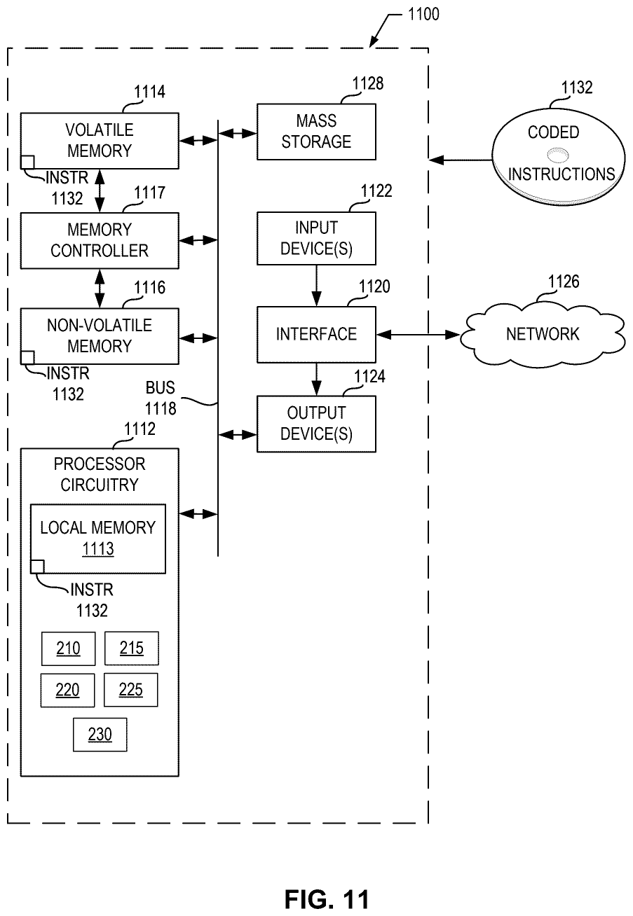

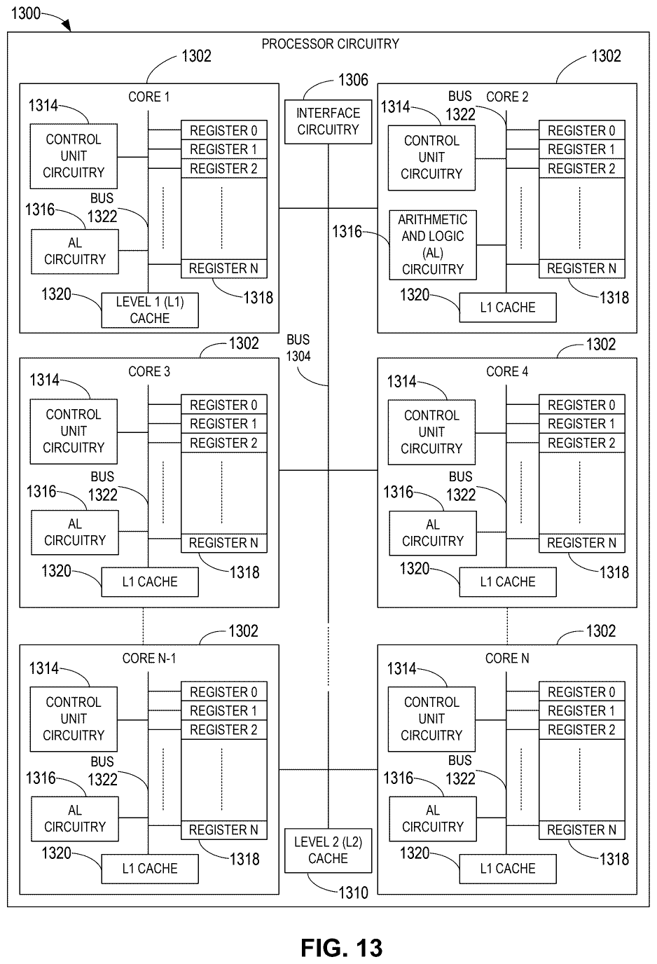

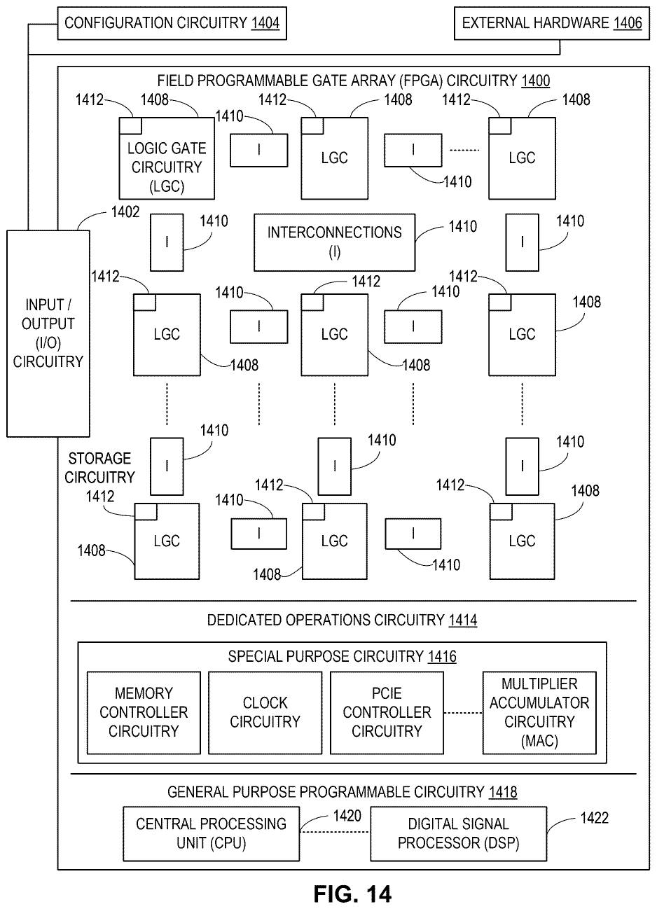

In some examples, the apparatus includes means for managing an application interface. For example, the means for managing an application interface may be implemented by the application interface manager circuitry 210. In some examples, the application interface manager circuitry 210 may be instantiated by programmable circuitry such as the example programmable circuitry 1112 of FIG. 11. For instance, the application interface manager circuitry 210 may be instantiated by the example microprocessor 1300 of FIG. 13 executing machine executable instructions such as those implemented by at least block 305 of FIG. 3. In some examples, the application interface manager circuitry 210 may be instantiated by hardware logic circuitry, which may be implemented by an ASIC, XPU, a graphics processing unit (GPU), a central processing unit (CPU), a vision processing unit (VPU), or the FPGA circuitry 1400 of FIG. 14 structured to perform operations corresponding to the machine readable instructions. Additionally or alternatively, the application interface manager circuitry 210 may be instantiated by any other combination of hardware, software, and/or firmware. For example, the application interface manager circuitry 210 may be implemented by at least one or more hardware circuits (e.g., processor circuitry, discrete and/or integrated analog and/or digital circuitry, an FPGA, an ASIC, an XPU, GPU, CPU, VPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The data flow tracker circuitry 215 performs data flow management in connection with the data provider. For example, one or more data provider(s) can generate a set of variables that can be associated with one or more data set(s) (e.g., for use in model training). In some examples, the data provider discovers one or more system(s) (e.g., chiplet associated with the training performer circuitry 205 disclosed herein) that can be potential consumers for the variables that the data provider generates. The data provider can initiate discovery in any form (e.g., broadcasting, discovery via a Domain Name System (DNS) or centralized services, etc.). While in examples disclosed herein the data provider initiates discovery of the system (e.g., chiplet associated with the training performer circuitry 205), the training performer circuitry 205 can also initiate discovery of the data provider, as needed. In examples disclosed herein, the data provider attests the authenticity of each system (e.g., chiplet associated with the training performer circuitry 205) that initiates a request of the data provider's proof-of-identity (e.g., a digital certificate that verifies the identity of the data provider) and/or when the data provider establishes a connection with a trusted server (e.g., a trusted AI server), as described in more detail in connection with FIG. 8. In examples disclosed herein, the trusted server is hosted in a trusted location (e.g., a location used by verified data provider(s) and/or system(s)). For example, the trusted server is hosted and/or owned by a trusted entity (e.g., entity verifiable via a digital certificate and/or a verification of authenticity, etc.). In some examples, the trusted server is a single entity and/or a distributed entity (e.g., allowing scalability).

As illustrated in more detail in connection with FIG. 8, once the data provider performs attestation and/or verifies the trust of the system(s) (e.g., chiplet associated with the training performer circuitry 205 and/or the trusted server), the data provider begins to stream variables associated with given data set(s) to the trusted systems. As previously described, trust and/or a trust attribute can be assigned to data, data set(s), data series and/or any other type of data-based information, as well as the one or more location(s) where the data and/or any type of data-based information is stored. In examples disclosed herein, once an identity of a given system (e.g., chiplet, server, etc.) is verified, the system is designated as a trusted system. In some examples, the trusted system(s) can register with the data provider to receive specific data set variable(s) and/or a given frequency of data receipt (e.g. every minute, hour, etc.). In some examples, the data generation can be event-based (e.g., depending on the desired type of data associated with model re-training and/or tuning). As described in more detail below in connection with the attestation performer circuitry 220, the data provider provides raw data for each of the data set variable(s) using a secured symmetric key generated as part of the data transmission.

In examples disclosed herein, the data flow tracker circuitry 215 manages data flow between a given data provider and the training performer circuitry 205. For example, the data flow tracker circuitry 215 identifies proof-of-identity requests received from the data provider. In some examples, the data flow tracker circuitry 215 generates a proof-of-identity using a private key of the chiplet after receiving a request from the data provider for the proof-of-identity. In some examples, the data provider establishes a secure asymmetric channel with a public identity of the target system (e.g., chiplet associated with the training performer circuitry 205). In some examples, the data flow tracker circuitry 215 establishes a connection with one or more data provider(s) based on a desired type and/or source of training data input. For example, if an AI model is trained using data from one or more data provider(s), the data flow tracker circuitry 215 can identify the data provider(s) of interest and/or the frequency of data receipt from the data provider(s) (e.g., based on the type of model being trained, the purpose of the model output(s), etc.). In some examples, the data flow tracker circuitry 215 can establish an event-based receipt of the training data from the data provider (e.g., using time-associated data), the event-based receipt based on an occurrence of an event associated with data generation by the data provider. In some examples, the data flow tracker circuitry 215 can establish a frequency-based receipt of the training data from the data provider, the frequency-based receipt based on temporal data generation by the data provider. In examples disclosed herein, the data flow tracker circuitry 215 provides the proof-of-identity requested by the data provider and the data provider initiates an attestation process to verify the identity of the training performer circuitry 205 via the trusted server. Subsequently, as described above, the data provider begins to stream variables associated with given data set(s) to the training performer circuitry 205, which can be received and/or processed by the data flow tracker circuitry 215.

In some examples, the apparatus includes means for tracking data flow. For example, the means for tracking data flow may be implemented by the data flow tracker circuitry 215. In some examples, the data flow tracker circuitry 215 may be instantiated by programmable circuitry such as the example programmable circuitry 1112 of FIG. 11. For instance, the data flow tracker circuitry 215 may be instantiated by the example microprocessor 1300 of FIG. 13 executing machine executable instructions such as those implemented by at least block 310 of FIG. 3. In some examples, the data flow tracker circuitry 215 may be instantiated by hardware logic circuitry, which may be implemented by an ASIC, XPU, GPU, CPU, VPU, or the FPGA circuitry 1400 of FIG. 14 structured to perform operations corresponding to the machine readable instructions. Additionally or alternatively, the data flow tracker circuitry 215 may be instantiated by any other combination of hardware, software, and/or firmware. For example, the data flow tracker circuitry 215 may be implemented by at least one or more hardware circuits (e.g., processor circuitry, discrete and/or integrated analog and/or digital circuitry, an FPGA, an ASIC, an XPU, GPU, CPU, VPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

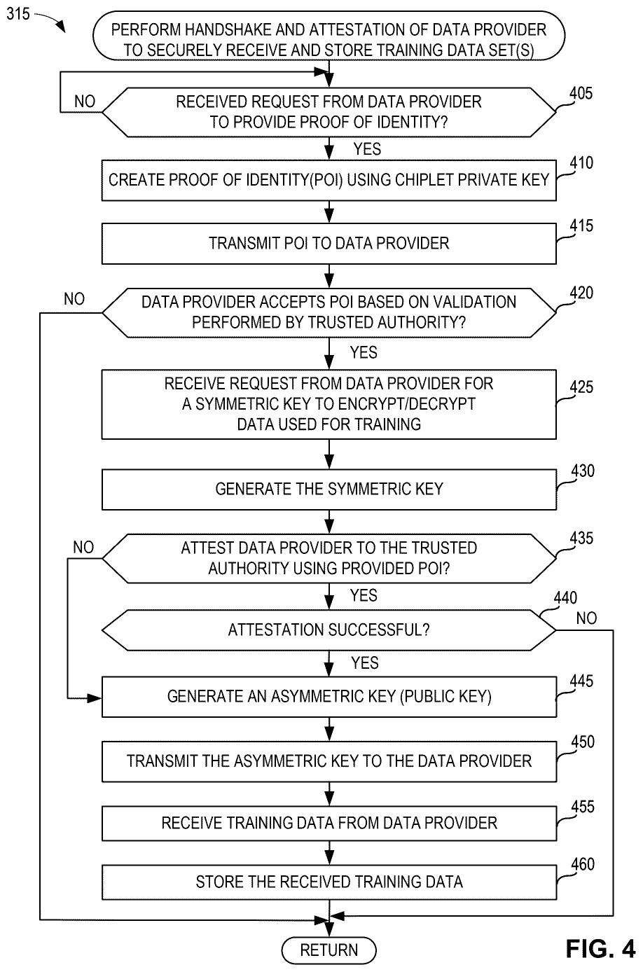

The attestation performer circuitry 220 performs attestation of the data provider to securely receive and/or store training data set(s), as described in more detail in connection with FIG. 4. In examples disclosed herein, the attestation performer circuitry 220 attests the identity of the data provider by receiving the data provider's proof-of-identity, as described in more detail below. In some examples, the attestation performer circuitry 220 attests the identity of the data provider using the trusted server, based on information provided to the trusted server via the data provider. After the attestation performer circuitry 220 verifies the data provider's proof-of-identity, the data flow tracker circuitry 215 discovers the type(s) of data sets and/or variables that can be accessed via the data provider. In some examples, the data flow tracker circuitry 215 registers with the data provider to receive data set(s) of interest.

In examples disclosed herein, the attestation performer circuitry 220 supervises and/or performs a handshake between the training performer circuitry 205 and the data provider. (e.g., allowing the training performer circuitry 205 and the data provider to establish a secure connection by authenticating the parties involved). For example, the data provider and the training performer circuitry 205 handshake using a symmetric key (e.g., a single key used to encrypt and decrypt data during a given session, ensuring both parties can securely exchange information with high speed and efficiency). As such, the symmetric key allows the training performer circuitry 205 to send and store data securely (e.g., via the data flow tracker circuitry 215). In some examples, establishing a connection between the training performer circuitry 205 and the data provider can involve the use of asymmetric encryption for initial key exchange, while the actual data encryption during the session is performed using a symmetric key (e.g., allowing for faster data processing speeds). In some examples, the attestation performer circuitry 220 performs attestation of the data provider using a first encryption key (e.g., an asymmetric key), such that the attestation is based on a validation of the data provider using a server (e.g., a trusted server). In some examples, the training reviewer circuitry 225 receives the training data from the data provider using a second encryption key (e.g., a symmetric key), where the first encryption key and the second encryption key are generated by a chiplet. In examples disclosed herein, the training performer circuitry 205 can be on an edge system located in proximity to the data provider (e.g., electronic proximity based on communication latency, geographic proximity, etc.). However, the location of the training performer circuitry 205 disclosed herein is not limited and can also be based on a data server located far from the data provider. While symmetric and asymmetric keys are used in the examples disclosed herein, any other type of encryption can be used (e.g. quantum encryption, etc.), since the training performer circuitry 205 can work with any type of secure channel.

In some examples, the apparatus includes means for performing attestation. For example, the means for performing attestation may be implemented by the attestation performer circuitry 220. In some examples, the attestation performer circuitry 220 may be instantiated by programmable circuitry such as the example programmable circuitry 1112 of FIG. 11. For instance, the attestation performer circuitry 220 may be instantiated by the example microprocessor 1300 of FIG. 13 executing machine executable instructions such as those implemented by at least block 435 of FIG. 4. In some examples, the attestation performer circuitry 220 may be instantiated by hardware logic circuitry, which may be implemented by an ASIC, XPU, GPU, CPU, VPU, or the FPGA circuitry 1400 of FIG. 14 structured to perform operations corresponding to the machine readable instructions. Additionally or alternatively, the attestation performer circuitry 220 may be instantiated by any other combination of hardware, software, and/or firmware. For example, the attestation performer circuitry 220 may be implemented by at least one or more hardware circuits (e.g., processor circuitry, discrete and/or integrated analog and/or digital circuitry, an FPGA, an ASIC, an XPU, GPU, CPU, VPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The training reviewer circuitry 225 prepares and/or evaluates data received from the data provider for re-training and/or tuning of the machine learning model(s) associated with the training performer circuitry 205 (e.g., using keys created during the handshake performed with the data provider). In some examples, the training reviewer circuitry 225 stores the raw data received from the data provider in the data storage (e.g., data storage 256). In examples disclosed herein, the training reviewer circuitry 225 categorizes data associated with the data provider into a data set mapper and/or a models key, as shown in connection with FIG. 8. For example, the training reviewer circuitry 225 identifies a type of machine learning model to be trained by the AI trainer circuitry 230 (e.g., AI model received from an AI application associated with a compute tile of the chiplet) and matches the model with the data set(s) received from the data provider for training of the AI model (e.g., based on data provider UUID, data set parameters, data set size, a model identifier, etc.).

In some examples, the apparatus includes means for reviewing training data. For example, the means for reviewing training data may be implemented by the training reviewer circuitry 225. In some examples, the training reviewer circuitry 225 may be instantiated by programmable circuitry such as the example programmable circuitry 1112 of FIG. 11. For instance, the training reviewer circuitry 225 may be instantiated by the example microprocessor 1300 of FIG. 13 executing machine executable instructions such as those implemented by at least blocks 455, 460 of FIG. 4. In some examples, the training reviewer circuitry 225 may be instantiated by hardware logic circuitry, which may be implemented by an ASIC, XPU, or the FPGA circuitry 1400 of FIG. 14 structured to perform operations corresponding to the machine readable instructions. Additionally or alternatively, the training reviewer circuitry 225 may be instantiated by any other combination of hardware, software, and/or firmware. For example, the training reviewer circuitry 225 may be implemented by at least one or more hardware circuits (e.g., processor circuitry, discrete and/or integrated analog and/or digital circuitry, an FPGA, an ASIC, an XPU, GPU, CPU, VPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The AI trainer circuitry 230 performs training (e.g., re-training, tuning, etc.) of machine learning model(s) associated with the training performer circuitry 205. In examples disclosed herein, the AI trainer circuitry 230 performs local training of the AI model(s) received from an AI application located on compute tile(s) of the chiplet, as shown in connection with FIG. 8. In some examples, the AI trainer circuitry 230 stores one or more version(s) of the trained, re-trained, and/or tuned AI model (e.g., in database 266). In some examples, the AI trainer circuitry 230 trains a given AI model locally for a given period of time. In some examples, the AI trainer circuitry 230 stores the one or more version(s) of the trained, re-trained, and/or tuned AI model at any other location(s) outside of the training performer circuitry 205 (e.g., between the database 266 and a cloud or server location). For example, using a corresponding private key for data security purposes, the AI trainer circuitry 230 can retrieve data set(s) received from the data provider (e.g., stored in the data storage 256). In some examples, the AI trainer circuitry 230 retrieves an original fully trained AI model (e.g., received from the AI application) from the data storage 256 to perform further re-training and/or tuning of the AI model based on the data set(s) received from the data provider. In some examples, the AI trainer circuitry 230 identifies the data set(s) to be used for the local training of the AI model based on the data set mapper and/or models key generated by the training reviewer circuitry 225. Once the AI trainer circuitry 230 retrains and/or tunes the AI model based on the received data set(s), the AI trainer circuitry 230 stores the updated model in the data storage 256. In some examples, the application interface manager circuitry 210 can retrieve the updated AI model from the data storage 256 and transmit the updated model to the AI application (e.g., located on the compute tile(s) of the chiplet associated with the training performer circuitry 205).

As illustrated in FIG. 2, the AI trainer circuitry 230 is in communication with a computing system 250 that trains a neural network to generate an example AI model 268 (e.g., a re-trained and/or tuned version of the fully trained AI model received from the AI application). For example, as described above, the AI trainer circuitry 230 identifies a pre-trained AI model for further retraining and/or tuning and performs local training of the AI model based on the data set(s) provided by the data provider. In some examples, the training data used for training during model generation includes any data received from a data provider. In some examples, the training data is labeled. In some examples, the training data is sub-divided such that a portion of the data is used for validation purposes.

Once training is complete, the AI model 268 is stored in one or more databases (e.g., database 266 of FIG. 2). One or more of the models may then be executed by, for example, the AI trainer circuitry 230. Once trained, the deployed model may be operated in an inference phase to process data. In the inference phase, data to be analyzed (e.g., live data) is input to the model, and the model executes to create an output. Moreover, in some examples, the output data may undergo post-processing after it is generated by the AI model to transform the output into a useful result (e.g., a display of data, an instruction to be executed by a machine, etc.). In some examples, output of the deployed model(s) may be captured and provided as feedback. By analyzing the feedback, an accuracy of the deployed model(s) can be determined. If the feedback indicates that the accuracy of the deployed model(s) is less than a threshold or other criterion, training of an updated model can be triggered using the feedback and an updated training data set, hyperparameters, etc., to generate an updated, deployed model(s).

As shown in FIG. 2, the computing system 250 trains a neural network to generate the AI model 268. The example computing system 250 includes a neural network processor 264. In examples disclosed herein, the neural network processor 264 implements a neural network. The computing system 250 of FIG. 2 also includes a neural network trainer 262. The neural network trainer 262 of FIG. 2 performs training of the neural network implemented by the neural network processor 264.

The computing system 250 of FIG. 2 includes a training controller 260. The training controller 260 instructs the neural network trainer 262 to perform training of the neural network based on training data 258. In the example of FIG. 2, the training data 258 used by the neural network trainer 262 to train the neural network is stored in a database 256 (e.g., where the database 256 can correspond to a data grouping and/or a collection of data set(s)). The example database 256 of the illustrated example of FIG. 2 is implemented by any memory, storage device and/or storage disc for storing data such as, for example, flash memory, magnetic media, optical media, etc. Furthermore, the data stored in the example database 256 may be in any data format such as, for example, binary data, comma delimited data, tab delimited data, structured query language (SQL) structures, image data, etc. While the illustrated example database 256 is illustrated as a single element, the database 256 and/or any other data storage elements described herein may be implemented by any number and/or type(s) of memories. The neural network trainer 262 trains the neural network implemented by the neural network processor 264 using the training data 258 to generate the AI model 268 as a result of the neural network training. The AI model 268 is stored in a database 266. The databases 256, 266 may be the same storage device or different storage devices.

In some examples, the apparatus includes means for training an AI model. For example, the means for training an AI model may be implemented by the AI trainer circuitry 230. In some examples, the AI trainer circuitry 230 may be instantiated by programmable circuitry such as the example programmable circuitry 1112 of FIG. 11. For instance, the AI trainer circuitry 230 may be instantiated by the example microprocessor 1300 of FIG. 13 executing machine executable instructions such as those implemented by at least block 325 of FIG. 3. In some examples, the AI trainer circuitry 230 may be instantiated by hardware logic circuitry, which may be implemented by an ASIC, XPU, GPU, CPU, VPU, or the FPGA circuitry 1400 of FIG. 14 structured to perform operations corresponding to the machine readable instructions. Additionally or alternatively, the AI trainer circuitry 230 may be instantiated by any other combination of hardware, software, and/or firmware. For example, the AI trainer circuitry 230 may be implemented by at least one or more hardware circuits (e.g., processor circuitry, discrete and/or integrated analog and/or digital circuitry, an FPGA, an ASIC, an XPU, GPU, CPU, VPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The data storage 240 can be used to store any information associated with the application interface manager circuitry 210, the data flow tracker circuitry 215, the attestation performer circuitry 220, the training reviewer circuitry 225, the AI trainer circuitry 230. The data storage 240 of the illustrated example of FIG. 2 can be implemented by any memory, storage device and/or storage disc for storing data such as flash memory, magnetic media, optical media, etc. Furthermore, the data stored in the data storage 240 can be in any data format such as binary data, comma delimited data, tab delimited data, structured query language (SQL) structures, image data, etc.

While an example manner of implementing the training performer circuitry 205 is illustrated in FIG. 2, one or more of the elements, processes and/or devices illustrated in FIG. 2 may be combined, divided, re-arranged, omitted, eliminated and/or implemented in any other way. Further, the example application interface manager circuitry 210, the example data flow tracker circuitry 215, the example attestation performer circuitry 220, the example training reviewer circuitry 225, the example AI trainer circuitry 230, and/or, more generally, the example training performer circuitry 205 of FIG. 2 may be implemented by hardware, software, firmware and/or any combination of hardware, software and/or firmware. Thus, for example, any of the example application interface manager circuitry 210, the example data flow tracker circuitry 215, the example attestation performer circuitry 220, the example training reviewer circuitry 225, the example AI trainer circuitry 230, and/or, more generally, the example training performer circuitry 205 of FIG. 2 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the training performer circuitry 205 of FIG. 2 may include one or more elements, processes, and/or devices in addition to, or instead of, those illustrated in FIG. 2, and/or may include more than one of any or all of the illustrated elements, processes and devices.

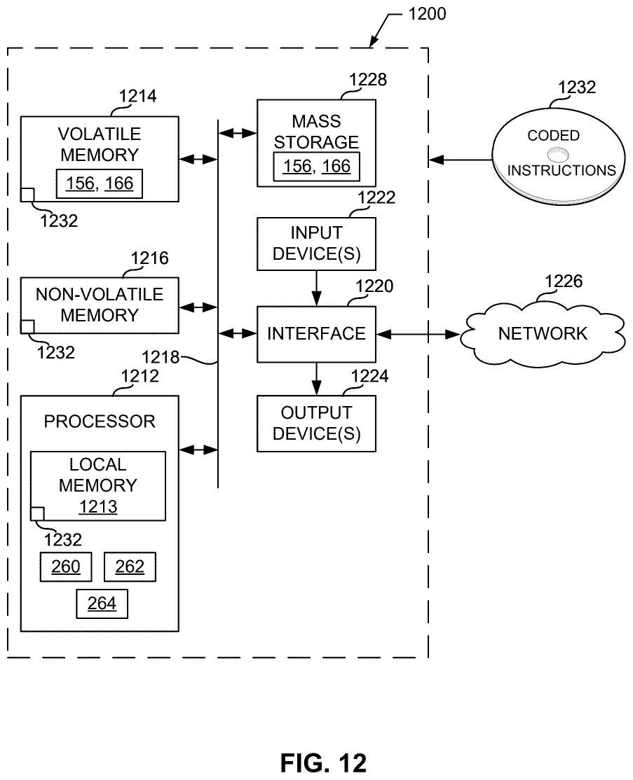

Flowcharts representative of example machine readable instructions, which may be executed by programmable circuitry to implement and/or instantiate the training performer circuitry 205 of FIG. 2 and/or representative of example operations which may be performed by programmable circuitry to implement and/or instantiate the computing system 250 of FIG. 2, are shown in FIGS. 3-6. The machine readable instructions may be one or more executable programs or portion(s) of one or more executable programs for execution by programmable circuitry, such as the programmable circuitry 1112, 1212 shown in the example processor platform(s) 1100, 1200 discussed below in connection with FIGS. 11-12 and/or may be one or more function(s) or portion(s) of functions to be performed by the example programmable circuitry (e.g., an FPGA) discussed below in connection with FIGS. 13 and/or 14. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 3-6, many other methods of implementing the example training performer circuitry 205 of FIG. 2 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 3-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine-readable instructions and/or example operations 300 that may be executed, instantiated, and/or performed by example programmable circuitry to implement the example training performer circuitry 205 of FIG. 2. The machine-readable instructions and/or the operations 300 of FIG. 3 begin at block 305, at which the application interface manager circuitry 210 receives a trained machine learning model (e.g., trained AI model) from an AI-based application associated with the software stack of a chiplet. For example, the AI application can be a personal assistant used to support a user with a given set of tasks. While the AI application can already include a fully trained AI model (e.g., trained using a first training and/or a previous training), the AI model may need to be re-trained and/or tuned to adjust one or more setting(s) of the model to improve the model's performance (e.g., identifying a combination of hyperparameters that improves the model's accuracy, generation quality, etc.). In examples disclosed herein, local re-training and/or tuning of the AI model is performed using the training performer circuitry 205 of FIG. 2 based on data set(s) made accessible to the training performer circuitry 205 by a data provider (e.g., a sensor, etc.). In some examples, the application interface manager circuitry 210 identifies a data provider with access to training data for performing a second training (e.g., a subsequent training) of a machine learning model, where the first training of the machine learning model is performed by a software stack of at least one of a chiplet associated with a system-on-a-chip (SoC), a chip portion of a chipset, or a die part. In some examples, the data provider(s) are linked to a database identifying the data provider-based sensor(s) that can provide information relevant to the local training of the AI model.

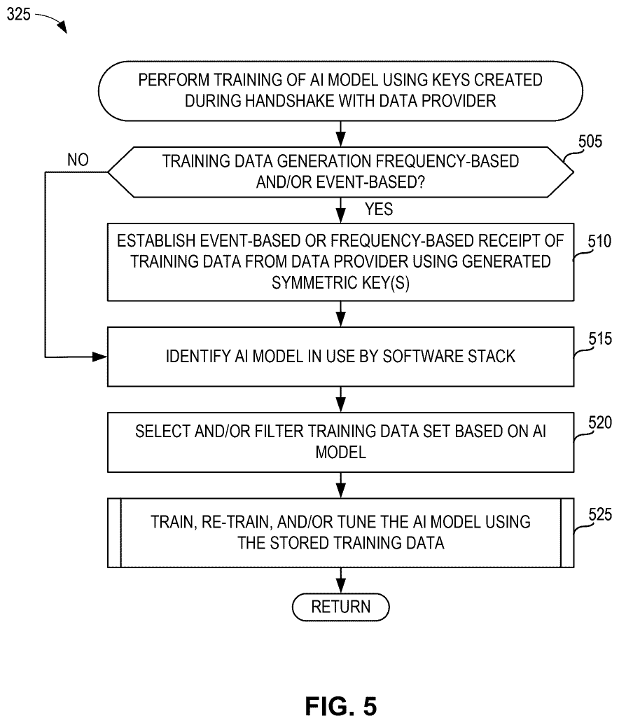

In some examples, the data flow tracker circuitry 215 identifies whether data set(s) from a data provider are available for the local re-training and/or tuning of the AI model, at block 310. In some examples, the data set(s) from the data provider can be identified based on a database of sensor(s) linked to a particular data provider. In some examples, the data provider can initiate registration with the chiplet to indicate the type(s) of sensor-based data available to the data provider. If the data set(s) are available, the training reviewer circuitry 225 proceeds to perform local training of the AI model (e.g., using keys created during a handshake of the training performer circuitry 205 and the data provider), at block 325. Otherwise, the attestation performer circuitry 220 performs a handshake with the data provider and/or performs attestation of the data provider to securely receive and store the training data set(s), at block 315, as described in more detail in connection with FIG. 4. Once the attestation performer circuitry 220 determines that attestation of the data provider is completed, the training reviewer circuitry 225 proceeds to perform local training of the AI model, at block 325, as described in connection with FIG. 5. In some examples, the application interface manager circuitry 210 returns the updated AI model to the software stack (e.g., to the AI application where the original fully trained AI model originated), at block 330.

FIG. 4 is a flowchart representative of example machine readable instructions and/or example operations 315 that may be executed, instantiated, and/or performed by programmable circuitry to implement the example training performer circuitry 205 of FIG. 2 to perform a handshake with and/or attestation of the data provider to securely receive and store the training data set(s). The machine-readable instructions and/or the operations 315 of FIG. 4 begin at block 405, at which the data flow tracker circuitry 215 receives a request from the data provider to provide a proof-of-identity (e.g., a digital certificate that verifies the identity of the data provider). In examples disclosed herein, the data flow tracker circuitry 215 creates the proof-of-identity (POI) using a private key associated with the chiplet, at block 410, and transmits the POI to the data provider, at block 415. In some examples, the data provider performs additional validation of the training performer circuitry 205 using a trusted authority (e.g., a trusted server). As described in connection with FIG. 2, the trusted server is a single entity and/or a distributed entity and can be hosted and/or owned by a trusted entity (e.g., entity verifiable via a digital certificate and/or a verification of authenticity, etc.). In some examples, information associated with the trusted server can be stored on the chiplet (e.g., a cache on the chiplet that locally stores information related to validations of the single and/or distributed entities associated with the trusted server).

For example, the data flow tracker circuitry 215 provides the POI requested by the data provider and the data provider initiates an attestation process to verify the identity of the training performer circuitry 205 via the trusted server, allowing for an additional layer of verification before the data provider proceeds to provide the training data set(s) to the training performer circuitry 205. Once the data provider has accepted the POI provided by the data flow tracker circuitry 215, the data flow tracker circuitry 215 can receive a request from the data provider for a symmetric key to encrypt and/or decrypt data used for model training, at block 425. In response, the data flow tracker circuitry 215 generates the symmetric key, at block 430. In some examples, the data provider generates a symmetric key to encrypt data that can be accessed by the training performer circuitry 205 from the data provider, such that the training performer circuitry 205 can obtain and validate the symmetric key to obtain access to the training data either through the data provider or through the trusted authority (e.g., trusted server), such that any software application(s) (e.g., an AI application associated with the software stack) in-between the training performer circuitry 205 and the data provider and/or trusted authority are not accessing the training data directly. In examples disclosed herein, establishing a connection between the training performer circuitry 205 and the data provider can also involve the use of asymmetric encryption for initial key exchange, while the actual data encryption during the session is performed using a symmetric key (e.g., allowing for faster data processing speeds). As such, methods and apparatus disclosed herein allow for data flow between a producer and a consumer, where the consumer is represented by the physical hardware (e.g., a chiplet) that is accessing the training data (e.g., as opposed to a software application performing the model training) from the data provider and/or the trusted authority via the exchange of keys.

In examples disclosed herein, the attestation performer circuitry 220 can also attest the data provider to the trusted authority (e.g., trusted server) using the POI associated with the data provider, at block 435. As such, the training performer circuitry 205 can verify that the data provider is a secure point of data transfer to the training performer circuitry 205 prior to receiving the training data from the data provider. If attestation of the data provider is successful, at block 440, the attestation performer circuitry 220 generates an asymmetric key, at block 445, and transmits the asymmetric key to the data provider, at block 450. Consequently, the training reviewer circuitry 225 receives training data from the data provider based on the established handshake and attestation of the data provider (e.g., via the trusted server), at block 455. The training reviewer circuitry 225 proceeds to store the received training data in a local data storage (e.g., data storage 256).

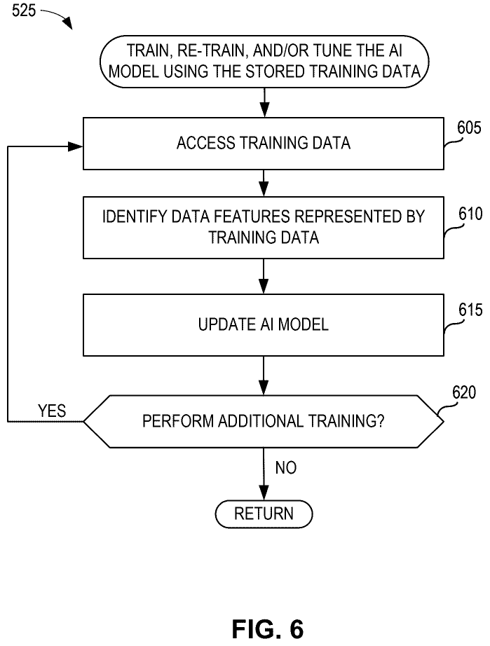

FIG. 5 is a flowchart representative of example machine-readable instructions and/or example operations 325 that may be executed, instantiated, and/or performed by example programmable circuitry to implement the example training performer circuitry 205 of FIG. 2 to perform training of the AI model using keys created during the handshake with the data provider. The machine-readable instructions and/or the operations 325 of FIG. 5 begin at block 505, at which the training reviewer circuitry 225 determines whether the training data generation is frequency-based and/or event-based. For example, the training reviewer circuitry 225 can determine that a particular AI model is trained using data provided at a given frequency (e.g., every minute) and/or after a given event (e.g., when a sensor identifies a change in temperature, motion, etc.). In some examples, the training reviewer circuitry 225 establishes an event-based or frequency-based receipt of training data from the data provider using the generated symmetric key(s), at block 510. Additionally, the training reviewer circuitry 225 identifies the type of AI model in use by the software stack of the chiplet (e.g., on which the training performer circuitry 205 is located), at block 515. For example, the type of AI model being trained can determine the type of training data needed for further re-training and/or tuning (e.g., type of sensor-based data originating from the data provider). As such, the training performer circuitry 205 selects and/or filters the training data set(s) (e.g., received from one or multiple data providers) based on the AI model type, at block 520. The training performer circuitry 205 provides the selected data to the AI trainer circuitry 230 to proceed with further training, re-training, and/or tuning of the AI model using the locally stored training data, at block 525, as described in more detail in connection with FIG. 6.

FIG. 6 is a flowchart representative of example machine-readable instructions and/or example operations 525 that may be executed, instantiated, and/or performed by example programmable circuitry to implement a computing system 250 of FIG. 2 to cause the computing system 250 to train, re-train, and/or tune the AI model using the stored training data. The machine readable instructions and/or the operations 525 of FIG. 6 begin at block 605, at which the AI trainer circuitry 230 accesses training data 228. The training data 228 can include any data received from the data provider (e.g., data sets associated with sensor readings, etc.). In some examples, the training data is labeled. In some examples, the training data is sub-divided such that a portion of the data is used for validation purposes. The trainer 262 identifies data features represented by the training data 258, at block 610. In some examples, the training controller 260 instructs the trainer 262 to perform training of the neural network using the training data 258 to generate the re-trained and/or tuned AI model 268, at block 615. In some examples, additional training is performed to refine the AI model 268, at block 620.

FIG. 7 illustrates a first example implementation 700 of a trusted training chiplet or device for AI model training in accordance with teachings of this disclosure for self-governing artificial intelligence (AI) models. In the example of FIG. 7, a trusted AI server 705 is in communication with an on-premise or edge-based computing system 710 (e.g., a chiplet associated with a system-on-a-chip (SoC), a chip portion of a chipset, a die part of a system, or any other local edge architecture) which includes the training performer circuitry 205 of FIG. 2. In the example of FIG. 7, the trusted AI server 705 includes a trusted AI service 715 and a first main computer 720. As described in connection with FIG. 2, the trusted AI server 705 is hosted in a trusted location (e.g., a location used by verified data provider(s) and/or system(s)). For example, the trusted AI server 705 is hosted and/or owned by a trusted entity (e.g., entity verifiable via a digital certificate and/or a verification of authenticity, etc.). In some examples, the trusted AI server 705 is a single entity and/or a distributed entity (e.g., allowing scalability). In the example of FIG. 7, the on-premise or edge-based computing system 710 receives data from a data provider 712 (e.g., a sensor), such that the data provided to the computing system 710 is encrypted data 714. The computing system 710 includes an AI application 722 (e.g., a personal assistant) and a second main computer 724, while the training performer circuitry 205 includes the AI trainer circuitry 230 of FIG. 2 (e.g., for training and/or re-training an AI model 732). As previously described in connection with FIG. 2, the AI trainer circuitry 230 can be in communication with the computing system 250 (not shown) to perform re-training and/or tuning of the AI model(s).

For example, the training performer circuitry 205 performs attestation of the data provider 712 (e.g., attest data provider 735) using the trusted AI service 715. In some examples, the training performer circuitry 205 verifies the identity of the data provider 712 using the trusted AI service 715, based on information provided to the trusted AI service 715 via the data provider 712. For example, the training performer circuitry 205 verifies the data provider's proof-of-identity (POI) prior to receiving any training data sets (e.g., raw data from sensors) from the data provider 712. Similarly, the data provider 712 performs attestation of the computing system 710 (e.g., attest training chiplet 740) prior to providing any data to the training performer circuitry 205. Once the training performer circuitry 205 receives the encrypted data 714, the training performer circuitry 205 stores the received data in a local database 730, allowing the AI trainer circuitry 230 to use the stored data for re-training and/or tuning the AI model 732. Once the AI model 732 is updated, the trained model is returned to the AI application 722 located on the computing system 710. In the example of FIG. 7, the training performer circuitry 205 allows the computing system 710 to train machine learning models with data sets that are not accessible to a software stack running in the bare-metal host (e.g., including the AI application 722). Likewise, the data provider 712 is equipped with logic that permits the data provider 712 to perform attestation of the training performer circuitry 205 via the trusted AI service 715. For example, as described in more detail in connection with FIG. 2, the data provider 712 and the training performer circuitry 205 perform a handshake and implement a symmetric key to send and/or store data from the data provider 712 securely in the training performer circuitry 205. Likewise, the training performer circuitry 205 can also perform attestation and/or validation of the data provider 712 prior to receipt of any data.

FIG. 8 illustrates a second example implementation 800 of a trusted training chiplet or device for AI model training in accordance with teachings of this disclosure for self-governing artificial intelligence (AI) models, including the use of the training performer circuitry 205 of FIG. 2. In the example of FIG. 8, a chiplet 802 includes main host compute tiles and/or resources where an operating system (OS) bare-metal executes, including a first compute tile 804, a second compute tile 806, a third compute tile 808, a first cache 810 (e.g., Level 3 (L3) cache), and a second cache 812 (e.g., MC cache). In the example of FIG. 8, the first compute tile 804, the second compute tile 806, and the third compute tile 808 include additional caches (e.g., caches 815, 820). The first and second compute tile(s) 804, 806 also include the AI application 722 (e.g., personal assistant). The chiplet 802 also includes a network on chip (NoC) 825 and the training performer circuitry 205 of FIG. 2. As discussed in connection with FIG. 2, the training performer circuitry 205 includes the application interface manager circuitry 210, the data flow tracker circuitry 215, the attestation performer circuitry 220, the training reviewer circuitry 225, the AI trainer circuitry 230, and the data storage(s) 256, 266.

For example, the application interface manager circuitry 210 receives a machine learning model (e.g., trained model 830) trained by the AI application 722 (e.g., trained model transmission 860). In some examples, the application interface manager circuitry 210 stores the trained model 830 in the data storage(s) 256, 266 (e.g., trained model storage 862). In some examples, the data flow tracker circuitry 215 performs a handshake with the data provider 712 to establish a secure channel to transmit data from the data provider 712. For example, the data flow tracker circuitry 215 can discover the training performer circuitry 205 and request proof-of-identity (POI) from the training performer circuitry 205 (e.g., data provider-initiated POI request 868). In return, the data flow tracker circuitry 215 provides the requested POI to the data provider 712 (e.g., POI transmission 870). Subsequently, the data provider 712 can attest the identity of the training performer circuitry 205 using the trusted AI server 705 (e.g., first attestation 873). In some examples, the attestation performer circuitry 220 also performs attestation of the data provider 712 via the trusted AI server 705 (e.g., second attestation 875). Once attestation is completed, the training reviewer circuitry 225 identifies relevant data set information from the data set(s) received from the data provider 712. For example, the training reviewer circuitry 225 generates a data set mapper 850 and/or a models key 855, allowing for identification of the data set type(s), AI model identifiers, data provider universally unique identifiers (UUIDs), and private keys (e.g., data set mapper generation 880, models key generation 882). The training reviewer circuitry 225 stores the received training data in the data storage 256, 266 and transmits the data set mapper 850 and/or models key 855 to the AI trainer circuitry 230 (e.g., training data transmission 885). The AI trainer circuitry 230 proceeds to re-train and/or tune the trained model 830, generating an updated AI model (e.g., AI model 268 of FIG. 2). The AI trainer circuitry 230 proceeds to store the updated AI model 268 in the data storage 256, 266 (e.g., model storage transmission 864), such that the updated model can be retrieved by the application interface manager circuitry 210 and returned to the software stack (e.g., AI application 722) (e.g., model return transmission 890).

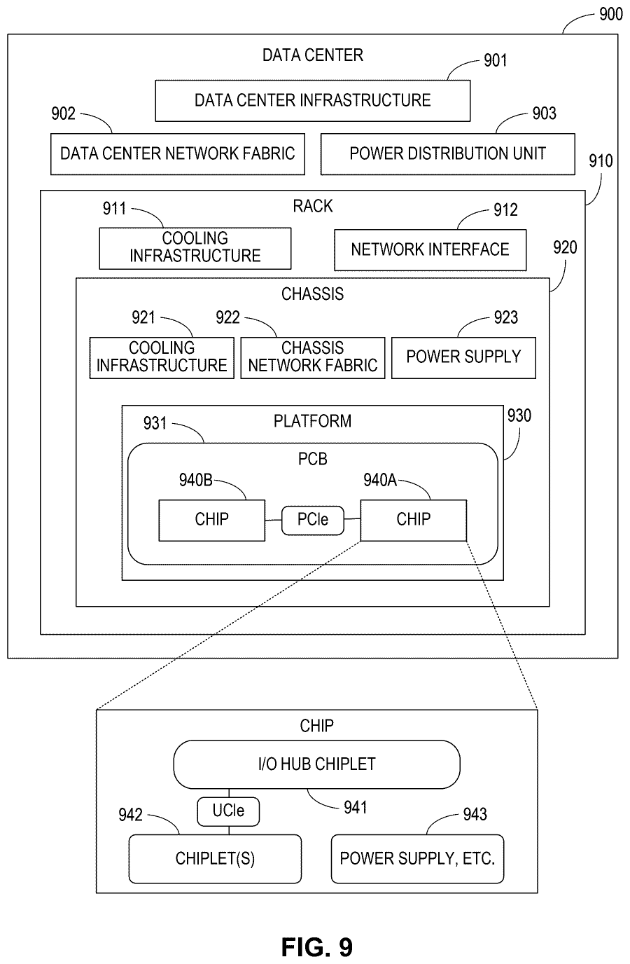

FIGS. 9, 10A, 10B, and 11 include example computing architectures in which any of the techniques and configurations above may be implemented.

FIG. 9 illustrates an example hardware arrangement of an example data center 900 used to provide multiple examples or instances of a computing system (e.g., the programmable circuitry platform 1100, described below), with each example of the computing system identified as a respective platform (e.g., the platform 930, described below). The data center 900 includes example data center infrastructure 901, an example data center network fabric 902, and an example power distribution unit 903 to support multiple racks of compute platforms, with a single instance of an example rack 910 depicted. The data center infrastructure 901 may provide physical components that host the compute platform hardware, storage components, and/or networking equipment. The data center network fabric 902 may include switches and/or networking components to support data flows among various compute platforms and storage devices throughout the data center. The power distribution unit 903 may include components to distribute and/or control power among the various compute platforms, networking, and storage devices.

The rack 910 of FIG. 9 includes, but is not limited to, example cooling infrastructure 911, an example network interface 912, and/or other related physical components to support discrete instances of multiple chassis. The rack 910 provides power, connectivity, and/or cooling to each of the multiple chassis in a single rack, with a single instance of a chassis 920 in the example of in FIG. 9. The chassis 920 includes, but is not limited to, example cooling infrastructure 921, an example chassis network fabric 922, and an example power supply 923, which provides cooling, network connectivity, and/or power to multiple platforms within the chassis. Although a single instance of an example platform 930 is illustrated in FIG. 9, in some examples, a common data center rack configuration may include dozens of chassis, with each chassis to support a number of platforms depending on the physical size of the platform hardware and/or supporting equipment.

The platform 930 of FIG. 9 may be referred to as a server or node, depending on the use case for the platform 930 and the data center 900. The platform 930 includes but is not limited to examples of a discrete computing system hosted on a single board. In FIG. 9, the platform 930 is illustrated as hosting a first example chip assembly 940A and a second example chip assembly 940B on a first board provided by a printed circuitry board (PCB) or other platform board, shown as an example PCB 931. In some examples, the platform 930 may include only one chip package, whereas the PCB 931 includes interconnection of multiple chip assemblies via an interface (e.g., a peripheral component interconnect express (PCIe) interface). Additional chip packages and components may also be hosted on the PCB 931.

Some examples of the chip assembly 940A, 940B of FIG. 9 may be termed as a System-on-Chip (SoC) package, as modular chiplets that perform different functions are integrated into a single package—even though this chip package is composed of multiple dies unlike a traditional SoC design that uses a single die. Other examples of the chip assembly 940A, 940B may include a System-on-Package (SoP), System-in-a-Package (SiP), or other single chip packages. Various combinations of 2 dimension (D), 2.5D, and/or 3D packaging technologies may be used to manufacture and/or assemble the chip package and its underlying structure. Additionally, different manufacturing processes may be used to provide chiplets and components from different process nodes (e.g., semiconductor fabrication systems).

The first chip assembly 940A and the second chip assembly 940B of FIG. 9 are packages that include multiple chiplets and/or dies for respective functions, such as separate chiplets for processing (e.g., central processing unit (CPU) or graphical processing unit (GPU) chiplets), memory (e.g., cache or high-bandwidth memory chiplets), input/output (I/O) (e.g., I/O chiplets), acceleration (e.g., artificial intelligence (AI)/machine learning (ML) acceleration chiplets), signal processing (e.g., audio or video processing chiplets), etc. The close-up of chip assembly 940A of FIG. 9 includes a I/O Hub chiplet 941, chiplets 942, and a power supply 943. These components may be hosted on an interposer that is designed to connect multiple dies and/or components within a single semiconductor package (e.g., chip package). In some examples, the chiplets 942 may be manufactured and/or sourced separately and later assembled into the chip package to create the chip assembly 940A. Various connections may be provided among the chiplets 942, such as with the use of Universal Chiplet Interconnect Express (UCIe) interfaces and communications, and/or between chiplets and on-chip memory (e.g., high-bandwidth memory (HBM)) using HBM3 (JEDEC), Universal Memory Interface (UMI), or other memory interfaces.

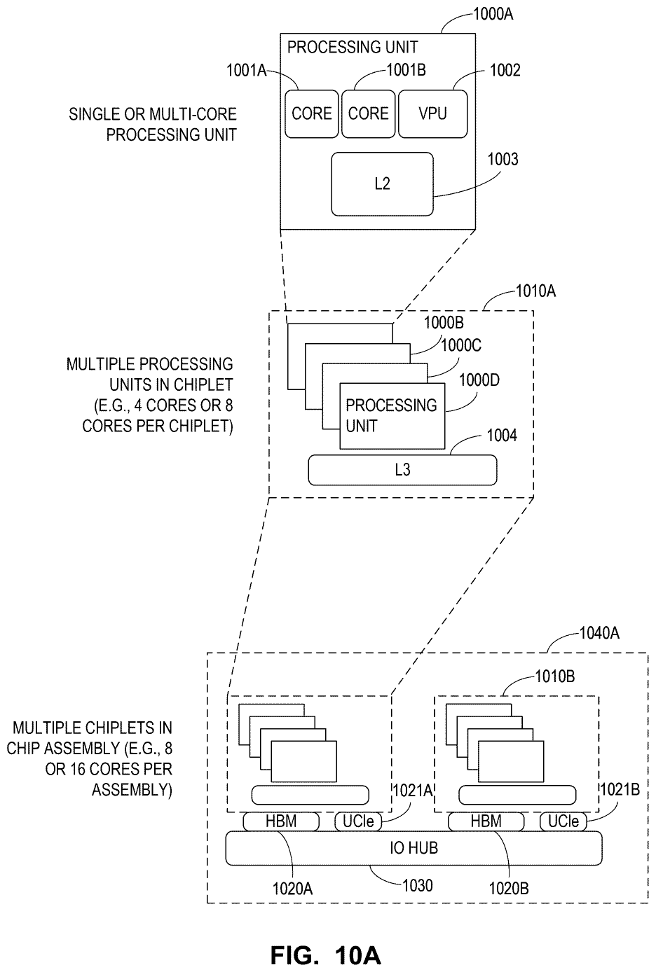

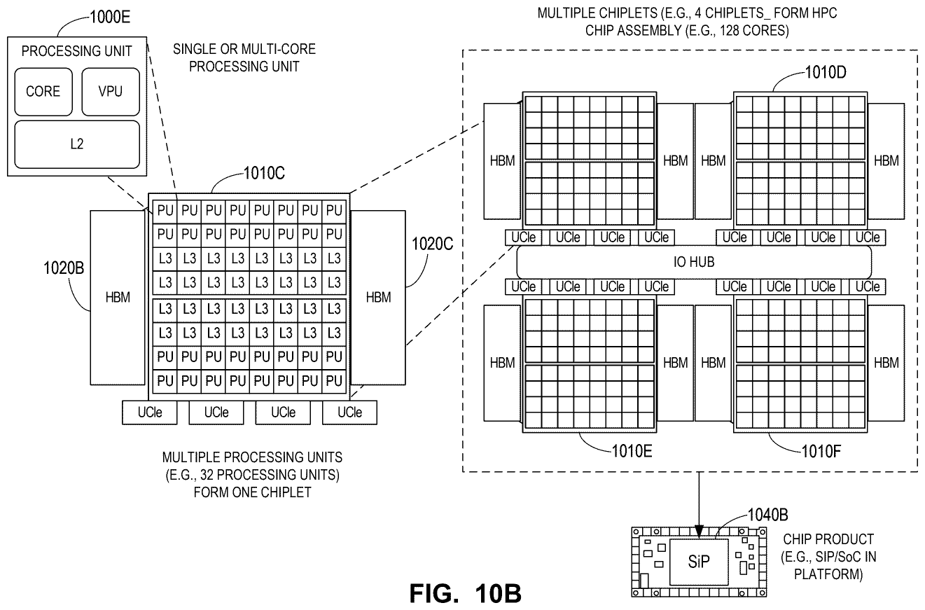

FIG. 10A illustrates an example arrangement of an example chip assembly 1040A (e.g., a multi-processing core example of the first chip assembly 940A or the second chip assembly 940B of FIG. 9), with expanded views of the chiplets and processing units included herein. In FIG. 10A the chip assembly 1040A, which may constitute a SoC, SoP, SiP, and/or other type of chip package, includes chiplets such as an example chiplet 1010A, an example chiplet 1010B, etc. and associated on-package memory (e.g., high-speed memory) such as 3D-stacked, High Bandwidth Memory (HBM) instances (shown as an example HBM 1020A, an example HBM 1020B, interfaces (e.g., UCIe interfaces) shown as an example UCIe 1021A, an example UCIe 1021B, and an example I/O hub 1030 (e.g., which may be implemented by a I/O chiplet). Other hardware elements of a chip package are not included for simplicity. Although the examples disclosed herein are described in conjunction with UCLe interfaces, one or more of the interfaces may be device-to-device (Dev2Dev) interfaces (e.g., CXLI, peripheral component interconnect express (PCIE)), die to die (D2D) interfaces (e.g., NVLINK), chiplet to chiplet (Ch2Ch) interfaces (e.g., universal chiplet interconnected express (UCIe)), core to core (C2C) interfaces (e.g., using coherency protocols), etc.

The chiplets 1010A, 1010B of FIG. 10A include multiple processing units and the example processing units 1000A, 1000B, 1000C, 1000D include one or multiple cores, respectively. For example, the chiplet 1010A of FIG. 10A includes four processing units (the processing units 1000A, 1000B, 1000C, 1000D) and an example Level 3 (L3) cache 1004. The processing units 1000A, 1000B, 1000C, 1000D may include one or multiple processing cores, one or multiple caches, other processing units and/or passive and/or active elements. For example, processing unit 1000A includes two cores (an example core 1001A and an example core 1001B), vector processing unit 1002, and an example level 2 (L2) cache 1003. Accordingly, a single-core processing unit can provide four cores per chiplet and eight total cores in a two-chiplet chip assembly, whereas a dual-core processing unit can provide eight cores per chiplet and sixteen total cores in a two-chiplet chip assembly. However, examples disclosed herein may correspond to other permutations.

FIG. 10B is an example arrangement of an example chip assembly 1040B (e.g., a multi-chiplet high-performance computing (HPC) example of chip assembly 940A, 940B), adapted for HPC applications (e.g., parallel processing operations involving thousands, millions, or more of processors and/or cores operating simultaneously). The example chip assembly 1040B illustrates placement as a SiP, SoC, and/or other package onto a platform board (e.g., the PCB 931 of FIG. 9). The platform board may be in a data center (e.g., the data center 900 of FIG. 9) or in a standalone deployment setting (e.g., in a standalone computer system, mobile computing device, autonomous device, etc.).

The chip assembly 1040B of FIG. 10B is composed of multiple chiplets, shown with four chiplets, including example chiplets 1010C, 1010D, 1010E, 1010F. The chiplets 1010C, 1010D, 1010E, 1010F include multiple processing units, such as thirty two processing units with a corresponding level 3 (L3) cache for each processing unit. The processing units may include one or multiple cores, such as an example single-core processing unit 1000E shown as part of the chiplet 1010C. The chip assembly 1040B also includes corresponding memory resources, such as HBM elements corresponding to respective banks of processing units (e.g., HBM 1020B and HBM 1020C corresponding respective sets of processing units of chiplet 1010C), UCIe interfaces, and/or an IO Hub.

The chip assembly and related products or devices described herein may be configured in a variety of computing system examples. Such examples include non-transitory machine-readable media storing machine-readable instructions and one or more processors coupled to the memory, such that executing the machine-readable instructions configure one or more of the processors and/or implementing hardware (e.g., the processing unit 1000, the chiplet 1010, the chip 940, and/or the platform 930 of FIGS. 9, 10A, and/or 10B) to perform operations described above for electronic systems or devices (e.g., to perform local machine learning model training, etc.). It should be further understood that software, including one or more machine readable instructions, that facilitate processing and operations as described above may be distributed, installed, or otherwise provided to networked devices (e.g., servers or cloud computing systems). Alternatively, in some examples, the software may be obtained and loaded (or, re-loaded/upgraded) from one or more servers and/or cloud computing systems, such as software stored on a server for distribution over the Internet, for example.

FIG. 11 is a block diagram of an example programmable circuitry platform 1100 structured to execute and/or instantiate the example machine-readable instructions and/or the example operations of FIGS. 3-6 to implement the training performer circuitry 205 of FIG. 2. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. In some examples, the programmable circuitry 1112 can be implemented by reduced instruction set computer (RISC)-V architecture and/or a chiplet (e.g., the chiplet assemblies 940A, 940B, 1040A, 1040B of FIGS. 9, 10A and/or 10B). The programmable circuitry 1112 may be implemented by one or more semiconductor based (e.g., silicon based) devices. In this example, the programmable circuitry 1112 implements the application interface manager circuitry 210, the data flow tracker circuitry 215, the attestation performer circuitry 220, the training reviewer circuitry 225, and the AI trainer circuitry 230.

In some examples, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of first circuitry at one point in time and reused by a second circuit in the first circuitry, or by a third circuit in a second circuitry at a different time.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 1120 may include an output interface, such as an interface connected to a display device, an input interface such as an interface connected to an alphanumeric input device or a user interface (UI) navigation device, or a communication interface. In some examples, a connected I/O device may also include a display device, an alphanumeric input device, and/or a navigation device that is integrated into a single unit, such as a touch screen display. The communication interface may provide a connection with a network interface device used to transmit and/or receive electronic signals on the network 1126. The programmable circuitry platform 1100 may also include other interfaces or hardware in connection with a signal generation device (e.g., an audio or radio signal generation device), an output controller (e.g., for connection with a serial, universal serial bus (USB), parallel, and/or other wired or wireless connection such as which uses via infrared (IR) and/or near field communication (NFC) technologies), an input controller (e.g., for connection with sensors or peripheral devices), etc.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 3-6, may be stored in the mass storage device 1128, in the volatile memory 1114, in the non-volatile memory 1116, and/or on at least one non-transitory computer readable storage medium such as a CD or DVD which may be removable. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 1132.

The instructions 1132 may reside, during execution and/or other operation of the programmable circuitry platform 1100, completely, or at least partially, within the volatile memory 1114, within non-volatile memory 1116, within the local memory 1113, within a removable storage, within a non-removable storage, and/or within the programmable circuitry 1112. Thus, any combination of the programmable circuitry 1112, the volatile memory 1114, the non-volatile memory 1116, the local memory 1113, and/or a storage device of the removable storage or non-removable storage may constitute a machine-readable medium or media. The instructions 1132, when loaded and executed by the programmable circuitry 1112, may invoke or utilize a defined instruction set 1132 of the programmable circuitry 1112, such as a processor instruction set defined by an instruction set architecture (ISA) of a reduced instruction set computer (RISC) or complex instruction set computer (CISC) architecture-including but not limited to the RISC-V Instruction Set provided in a RISC-V architecture. A RISC-V architecture and instruction set is one of several available architectures and instruction sets that may be used in examples of the compute components (e.g., the programmable circuitry 1112) described herein.

FIG. 12 is a block diagram of an example programmable circuitry platform 1200 structured to execute and/or instantiate the example machine-readable instructions and/or the example operations of FIG. 6 to implement the example computing system 250 of FIG. 2. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs microprocessors, CPUs, GPUs, DSPs, and/or microcontrollers from any desired family or manufacturer. The programmable circuitry 1212 may be implemented by one or more semiconductor based (e.g., silicon based) devices. In this example, the programmable circuitry 1012 implements the example neural network processor 264, the example trainer 262, and the example training controller 260.

The programmable circuitry 1212 of the illustrated example includes a local memory 1213 (e.g., a cache, registers, etc.). The programmable circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output devices 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1200 of the illustrated example also includes one or more mass storage devices 1228 to store software and/or data. Examples of such mass storage devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1232, which may be implemented by the machine readable instructions of FIG. 6, may be stored in the mass storage device 1228, in the volatile memory 1214, in the non-volatile memory 1216, and/or on at least one non-transitory computer readable storage medium such as a CD or DVD which may be removable.

FIG. 13 is a block diagram of an example implementation of the programmable circuitry 1112, 1212 of FIGS. 11-12. In this example, the programmable circuitry 1112, 1212 of FIGS. 11-12 is implemented by a microprocessor 1300. For example, the microprocessor 1300 may be a general-purpose microprocessor (e.g., general-purpose microprocessor circuitry). The microprocessor 1300 executes some or all of the machine-readable instructions of the flowcharts of FIGS. 3-6 to effectively instantiate the circuitry of FIG. 2 as logic circuits to perform operations corresponding to those machine readable instructions. In some such examples, the circuitry of FIG. 2 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 3-6.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating-point operations. In yet other examples, the AL circuitry 1316 may include first AL circuitry that performs integer-based operations and second AL circuitry that performs floating-point operations. In some examples, the AL circuitry 1316 may be referred to as an Arithmetic Logic Unit (ALU).

The registers 1318 are semiconductor-based structures to store data and/or instructions such as results of one or more of the operations performed by the AL circuitry 1316 of the corresponding core 1302. For example, the registers 1318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure, such as by being distributed throughout the core 1302 to shorten access time. The second bus 1322 may be implemented by at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages.

The microprocessor 1300 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1300, in the same chip package as the microprocessor 1300 and/or in one or more separate packages from the microprocessor 1300.

FIG. 14 is a block diagram of another example implementation of the programmable circuitry 1112, 1212 of FIGS. 11-12. In this example, the programmable circuitry 1112, 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine readable instructions represented by the flowchart(s) of FIGS. 3-6 but whose interconnections and logic circuitry are fixed once fabricated), the FPGA circuitry 1400 of the example of FIG. 14 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-6. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-6. As such, the FPGA circuitry 1400 may be configured and/or structured to effectively instantiate some or all of the operations/functions corresponding to the machine readable instructions of the flowchart(s) of FIGS. 3-6 as dedicated logic circuits to perform the operations/functions corresponding to those software instructions in a dedicated manner analogous to an ASIC. Therefore, the FPGA circuitry 1400 may perform the operations/functions corresponding to the some or all of the machine readable instructions of FIGS. 3-6 faster than the general-purpose microprocessor can execute the same.

In the example of FIG. 14, the FPGA circuitry 1400 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain a binary file, which may be implemented by a bit stream, data, and/or machine-readable instructions, to configure the FPGA circuitry 1400, or portion(s) thereof. In some such examples, the configuration circuitry 1404 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine readable instructions of FIGS. 3-6 and/or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the programmable circuitry 1112, 1212 of FIGS. 11-12, many other approaches are contemplated. For example, FPGA circuitry may include an on-board CPU, such as one or more of the example CPU 1420 of FIG. 13. Therefore, the programmable circuitry 1112, 1212 of FIGS. 11-12 may additionally be implemented by combining at least the example microprocessor 1300 of FIG. 13 and the example FPGA circuitry 1400 of FIG. 14. In some such hybrid examples, one or more cores 1302 of FIG. 13 may execute a first portion of the machine readable instructions represented by the flowchart(s) of FIGS. 3-6 to perform first operation(s)/function(s), the FPGA circuitry 1400 of FIG. 14 may be configured and/or structured to perform second operation(s)/function(s) corresponding to a second portion of the machine readable instructions represented by the flowcharts of FIG. 3-6, and/or an ASIC may be configured and/or structured to perform third operation(s)/function(s) corresponding to a third portion of the machine readable instructions represented by the flowcharts of FIGS. 3-6.

It should be understood that some or all of the circuitry of FIG. 2 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1300 of FIG. 13 may execute machine readable instructions in one or more threads executing concurrently and/or in series. In some examples, the FPGA circuitry 1400 of FIG. 14 may be configured and/or structured to carry out operations/functions concurrently and/or in series. Moreover, in some examples, some or all of the circuitry of FIG. 2 may be implemented within one or more virtual machines and/or containers executing on the microprocessor 1300 of FIG. 13.

In some examples, the programmable circuitry 1112, 1212 of FIGS. 11-12 may be in one or more packages. For example, the microprocessor 1300 of FIG. 13 and/or the FPGA circuitry 1400 of FIG. 14 may be in one or more packages. In some examples, an XPU may be implemented by the programmable circuitry 1112, 1212 of FIGS. 11-12, which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

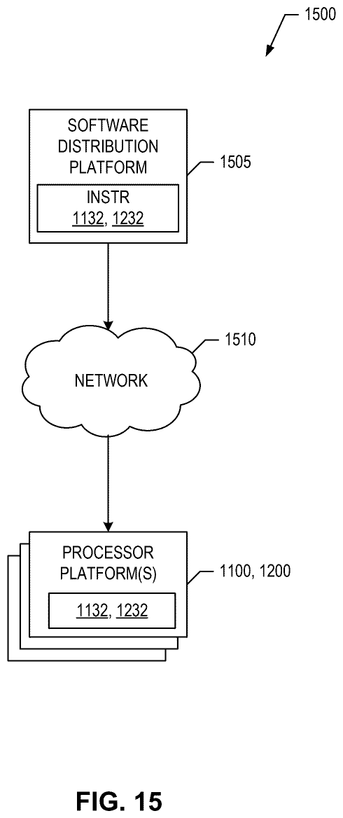

A block diagram illustrating an example software distribution platform 1505 to distribute software such as the example machine readable instructions 1132, 1232 of FIGS. 11-12 to other hardware devices (e.g., hardware devices owned and/or operated by third parties from the owner and/or operator of the software distribution platform) is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1132, 1232 of FIGS. 11-12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1132, 1232 which may correspond to the example machine readable instructions of FIGS. 3-6, as described above. The one or more servers of the example software distribution platform 1505 are in communication with an example network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132, 1232 from the software distribution platform 1505. For example, the software, which may correspond to the example machine readable instructions of FIG. 3-6, may be downloaded to the example programmable circuitry platform(s) 1100, 1200 which is to execute the machine readable instructions 1132, 1232 to implement the training performer circuitry 205. In some examples, one or more servers of the software distribution platform 1505 periodically offer, transmit, and/or force updates to the software (e.g., the example machine readable instructions 1132, 1232 of FIGS. 11-12) to ensure improvements, patches, updates, etc., are distributed and applied to the software at the end user devices. Although referred to as software above, the distributed “software” could alternatively be firmware.

The instructions 1132, 1232 may be transmitted or received over the network 1510 using a transmission medium via the interface circuitry 1120, 1220 of FIGS. 11-12 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and/or wireless data networks (e.g., Institute of Electrical and Electronics Engineers (IEEE) 802.11 family of standards known as Wi-Fi®), IEEE 802.15.4 family of standards, peer-to-peer (P2P) networks, among others.

A computing program may be written in any form of programming language, including compiled or interpreted languages, and it may be deployed in any form, including as a stand-alone program and/or as a module, component, subroutine, and/or other unit suitable for use in a computing environment. Also, programs, codes, and/or code segments for accomplishing the techniques described herein are construed as within the scope of the present disclosure by programmers of ordinary skill in the art.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein allow for a chiplet and/or a subsystem to perform AI model training without providing access of the training data to any software stack running in a server location, thereby improving raw data security and ensuring a high level of data privacy. In examples disclosed herein, raw data (e.g., machine learning model training data) is securely stored in a trusted training component, becoming accessible to software with access to a given hardware application programming interface (API). In examples disclosed herein, the trusted training component includes (1) an API associated with proof-of-identity, allowing a given data provider to validate the entity of the trusted training component, (2) an API to establish communication between the data provider and the trusted training component (e.g., for sending or streaming data sets used as part of training the machine learning model, etc.), and/or (3) an API to allow software stack running in a separate compute element (e.g., to perform training, re-training, and/or tuning of the machine learning model using a given data set). In examples disclosed herein, the trusted training component is part of a chiplet designed to support data flow management, attestation management, and/or training management associated with the training data received from a data provider. Disclosed systems, methods, apparatus, and articles of manufacture are accordingly directed to one or more improvement(s) in the operation of a machine such as a computer.

Example methods, apparatus, systems, and articles of manufacture for artificial intelligence model security protection using moving target defenses are disclosed herein. Further examples and combinations thereof include the following:

Example 1 includes an apparatus, comprising interface circuitry, machine-readable instructions, and at least one processor circuit to be programmed by the machine-readable instructions to identify a data provider with access to training data for performing a second training of a machine learning model, a first training of the machine learning model performed by a software stack of at least one of a chiplet associated with a system-on-a-chip (SoC), a chip portion of a chipset, or a die part, perform attestation of the data provider using a first encryption key, the attestation based on a validation of the data provider using a server, receive the training data from the data provider using a second encryption key, the first encryption key and the second encryption key generated by the at least one of the chiplet, the chip portion of the chipset, or the die part, and perform the second training of the machine learning model using the training data stored locally on the at least one of the chiplet, the chip portion of the chipset, or the die part.

Example 2 includes the apparatus of any one or more of the foregoing examples, wherein the data provider is a sensor, the sensor at least one of a camera, a temperature sensor, a pressure sensor, a humidity sensor, a proximity sensor, a light sensor, an ultrasound sensor, an optical sensor, or a motion sensor.

Example 3 includes the apparatus of any one or more of the foregoing examples, wherein one or more of the at least one processor circuit is to create a proof-of-identity using a private key of the at least one of the chiplet, the chip portion of the chipset, or the die part after the data provider issues a request for the proof-of-identity.

Example 4 includes the apparatus of any one or more of the foregoing examples, wherein the server is associated with a trusted authority that validates an authenticity of the data provider using the proof-of-identity, the trusted authority identified using at least one of a certificate or a verification of authenticity.

Example 5 includes the apparatus of any one or more of the foregoing examples, wherein the server is at least one of a single entity or a distributed entity.

Example 6 includes the apparatus of any one or more of the foregoing examples, wherein one or more of the at least one processor circuit is to establish an event-based receipt of the training data from the data provider, the event-based receipt based on an occurrence of an event associated with data generation by the data provider.

Example 7 includes the apparatus of any one or more of the foregoing examples, wherein one or more of the at least one processor circuit is to establish a frequency-based receipt of the training data from the data provider, the frequency-based receipt based on temporal data generation by the data provider.

Example 8 includes the apparatus of any one or more of the foregoing examples, wherein one or more of the at least one processor circuit is to provide the machine learning model modified based on the training data to the software stack.

Example 9 includes the apparatus of any one or more of the foregoing examples, wherein the first encryption key is an asymmetric key and the second encryption key is a symmetric key.

Example 10 includes at least one non-transitory machine-readable medium comprising machine-readable instructions to cause at least one processor circuit to at least identify a data provider with access to training data for performing a second training of a machine learning model, a first training of the machine learning model performed by a software stack of at least one of a chiplet associated with a system-on-a-chip (SoC), a chip portion of a chipset, or a die part, perform attestation of the data provider using a first encryption key, the attestation based on a validation of the data provider using a server, receive the training data from the data provider using a second encryption key, the first encryption key and the second encryption key generated by the at least one of the chiplet, the chip portion of the chipset, or the die part, and perform the second training of the machine learning model using the training data stored locally on the at least one of the chiplet, the chip portion of the chipset, or the die part.

Example 11 includes the at least one non-transitory machine-readable medium of any one or more of the foregoing examples, wherein the data provider is a sensor, the sensor at least one of a camera, a temperature sensor, a pressure sensor, a humidity sensor, a proximity sensor, a light sensor, an ultrasound sensor, an optical sensor, or a motion sensor.

Example 12 includes the at least one non-transitory machine-readable medium of any one or more of the foregoing examples, wherein the first encryption key is an asymmetric key and the second encryption key is a symmetric key.

Example 13 includes the at least one non-transitory machine-readable medium of any one or more of the foregoing examples, wherein the machine-readable instructions are to cause one or more of the at least one processor circuit to create a proof-of-identity using a private key of the at least one of the chiplet, the chip portion of the chipset, or the die part after the data provider issues a request for the proof-of-identity.

Example 14 includes the at least one non-transitory machine-readable medium of any one or more of the foregoing examples, wherein the server is associated with a trusted authority that validates an authenticity of the data provider using the proof-of-identity, the trusted authority identified using at least one of a certificate or a verification of authenticity.

Example 15 includes the at least one non-transitory machine-readable medium of any one or more of the foregoing examples, wherein the server is at least one of a single entity or a distributed entity.

Example 16 includes the at least one non-transitory machine-readable medium of any one or more of the foregoing examples, wherein the machine-readable instructions are to cause one or more of the at least one processor circuit to establish an event-based receipt of the training data from the data provider, the event-based receipt based on an occurrence of an event associated with data generation by the data provider.

Example 17 includes the at least one non-transitory machine-readable medium of any one or more of the foregoing examples, wherein the machine-readable instructions are to cause one or more of the at least one processor circuit to establish a frequency-based receipt of the training data from the data provider, the frequency-based receipt based on temporal data generation by the data provider.

Example 18 includes the at least one non-transitory machine-readable medium of any one or more of the foregoing examples, wherein the machine-readable instructions are to cause one or more of the at least one processor circuit to provide the machine learning model modified based on the training data to the software stack.

Example 19 includes an apparatus, comprising means for managing an application interface to identify a data provider with access to training data for performing a second training of a machine learning model, a first training of the machine learning model performed by a software stack of at least one of a chiplet associated with a-on-a-chip (SoC), a chip portion of a chipset, or a die part, means for performing attestation of the data provider using a first encryption key, the attestation based on a validation of the data provider using a server, means for reviewing training data to receive the training data from the data provider using a second encryption key, the first encryption key and the second encryption key generated by the at least one of the chiplet, the chip portion of the chipset, or the die part, and means for training an AI model to perform the second training of the machine learning model using the training data stored locally on the at least one of the chiplet, the chip portion of the chipset, or the die part.

Example 20 includes the apparatus of any one or more of the foregoing examples, wherein the data provider is a sensor, the sensor at least one of a camera, a temperature sensor, a pressure sensor, a humidity sensor, a proximity sensor, a light sensor, an ultrasound sensor, an optical sensor, or a motion sensor.

Example 21 includes the apparatus of any one or more of the foregoing examples, wherein the first encryption key is an asymmetric key and the second encryption key is a symmetric key.

Example 22 includes the apparatus of any one or more of the foregoing examples, further including a means for tracking data flow is to create a proof-of-identity using a private key of the at least one of the chiplet, the chip portion of the chipset, or the die part after the data provider issues a request for the proof-of-identity.

Example 23 includes the apparatus of any one or more of the foregoing examples, wherein the server is associated with a trusted authority that validates an authenticity of the data provider using the proof-of-identity, the trusted authority identified using at least one of a certificate or a verification of authenticity.

Example 24 includes the apparatus of any one or more of the foregoing examples, wherein the server is at least one of a single entity or a distributed entity.

Example 25 includes the apparatus of any one or more of the foregoing examples, further including a means for tracking data to establish an event-based receipt of the training data from the data provider, the event-based receipt based on an occurrence of an event associated with data generation by the data provider.

Example 26 includes the apparatus of any one or more of the foregoing examples, further including a means for tracking data to establish a frequency-based receipt of the training data from the data provider, the frequency-based receipt based on temporal data generation by the data provider.

Example 27 includes the apparatus of any one or more of the foregoing examples, wherein the means for managing an application interface is to return the machine learning model to the software stack, the machine learning model trained or tuned based on the training data.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
interface circuitry;
machine-readable instructions; and
at least one processor circuit to be programmed by the machine-readable instructions to:
identify a data provider with access to training data for performing a second training of a machine learning model, a first training of the machine learning model performed by a software stack of at least one of a chiplet associated with a system-on-a-chip (SoC), a chip portion of a chipset, or a die part;
perform attestation of the data provider using a first encryption key, the attestation based on a validation of the data provider using a server;
receive the training data from the data provider using a second encryption key, the first encryption key and the second encryption key generated by the at least one of the chiplet, the chip portion of the chipset, or the die part; and
perform the second training of the machine learning model using the training data stored locally on the at least one of the chiplet, the chip portion of the chipset, or the die part.

2. The apparatus of claim 1, wherein the data provider is a sensor, the sensor at least one of a camera, a temperature sensor, a pressure sensor, a humidity sensor, a proximity sensor, a light sensor, an ultrasound sensor, an optical sensor, or a motion sensor.

3. The apparatus of claim 1, wherein one or more of the at least one processor circuit is to create a proof-of-identity using a private key of the at least one of the chiplet, the chip portion of the chipset, or the die part after the data provider issues a request for the proof-of-identity.

4. The apparatus of claim 3, wherein the server is associated with a trusted authority that validates an authenticity of the data provider using the proof-of-identity, the trusted authority identified using at least one of a certificate or a verification of authenticity.

5. The apparatus of claim 1, wherein one or more of the at least one processor circuit is to establish an event-based receipt of the training data from the data provider, the event-based receipt based on an occurrence of an event associated with data generation by the data provider.

6. The apparatus of claim 1, wherein one or more of the at least one processor circuit is to establish a frequency-based receipt of the training data from the data provider, the frequency-based receipt based on temporal data generation by the data provider.

7. The apparatus of claim 1, wherein one or more of the at least one processor circuit is to provide the machine learning model modified based on the training data to the software stack.

8. At least one non-transitory machine-readable medium comprising machine-readable instructions to cause at least one processor circuit to at least:
identify a data provider with access to training data for performing a second training of a machine learning model, a first training of the machine learning model performed by a software stack of at least one of a chiplet associated with a system-on-a-chip (SoC), a chip portion of a chipset, or a die part;
perform attestation of the data provider using a first encryption key, the attestation based on a validation of the data provider using a server;
receive the training data from the data provider using a second encryption key, the first encryption key and the second encryption key generated by the at least one of the chiplet, the chip portion of the chipset, or the die part; and
perform the second training of the machine learning model using the training data stored locally on the at least one of the chiplet, the chip portion of the chipset, or the die part.

9. The at least one non-transitory machine-readable medium of claim 8, wherein the data provider is a sensor, the sensor at least one of a camera, a temperature sensor, a pressure sensor, a humidity sensor, a proximity sensor, a light sensor, an ultrasound sensor, an optical sensor, or a motion sensor.

10. The at least one non-transitory machine-readable medium of claim 8, wherein the machine-readable instructions are to cause one or more of the at least one processor circuit to create a proof-of-identity using a private key of the at least one of the chiplet, the chip portion of the chipset, or the die part after the data provider issues a request for the proof-of-identity.

11. The at least one non-transitory machine-readable medium of claim 10, wherein the server is associated with a trusted authority that validates an authenticity of the data provider using the proof-of-identity, the trusted authority identified using at least one of a certificate or a verification of authenticity.

12. The at least one non-transitory machine-readable medium of claim 8, wherein the machine-readable instructions are to cause one or more of the at least one processor circuit to establish an event-based receipt of the training data from the data provider, the event-based receipt based on an occurrence of an event associated with data generation by the data provider.

13. The at least one non-transitory machine-readable medium of claim 8, wherein the machine-readable instructions are to cause one or more of the at least one processor circuit to establish a frequency-based receipt of the training data from the data provider, the frequency-based receipt based on temporal data generation by the data provider.

14. The at least one non-transitory machine-readable medium of claim 8, wherein the machine-readable instructions are to cause one or more of the at least one processor circuit to provide the machine learning model modified based on the training data to the software stack.

15. An apparatus, comprising:
means for managing an application interface to identify a data provider with access to training data for performing a second training of a machine learning model, a first training of the machine learning model performed by a software stack of at least one of a chiplet associated with a system-on-a-chip (SoC), a chip portion of a chipset, or a die part;
means for performing attestation of the data provider using a first encryption key, the attestation based on a validation of the data provider using a server;
means for reviewing training data to receive the training data from the data provider using a second encryption key, the first encryption key and the second encryption key generated by the at least one of the chiplet, the chip portion of the chipset, or the die; and
means for training an AI model to perform the second training of the machine learning model using the training data stored locally on the at least one of the chiplet, the chip portion of the chipset, or the die part.

16. The apparatus of claim 15, wherein the data provider is a sensor, the sensor at least one of a camera, a temperature sensor, a pressure sensor, a humidity sensor, a proximity sensor, a light sensor, an ultrasound sensor, an optical sensor, or a motion sensor.

17. The apparatus of claim 15, further including a means for tracking data flow is to create a proof-of-identity using a private key of the at least one of the chiplet, the chip portion of the chipset, or the die part after the data provider issues a request for the proof-of-identity.

18. The apparatus of claim 17, wherein the server is associated with a trusted authority that validates an authenticity of the data provider using the proof-of-identity, the trusted authority identified using at least one of a certificate or a verification of authenticity.

19. The apparatus of claim 15, further including a means for tracking data to establish an event-based receipt of the training data from the data provider, the event-based receipt based on an occurrence of an event associated with data generation by the data provider.

20. The apparatus of claim 15, further including a means for tracking data to establish a frequency-based receipt of the training data from the data provider, the frequency-based receipt based on temporal data generation by the data provider.
